(19) United States
(12) Patent Application Publication
(10) Pub. No.: US 2018/0171631 A1
(43) Pub. Date: Jun. 21, 2018

(54) POLYESTER-BASED TAPE COMPOSITES FOR CONSTRUCTION PANEL REINFORCEMENT

(71) Applicant: Eastman Chemical Company, Kingsport, TN (US)

(72) Inventors: Jeremy Hager Klug, Kingsport, TN (US); Mark Allan Treece, Jonesborough, TN (US); Kaitlyn Elizabeth Ailey, Johnson City, TN (US); Kendrick Casey Halsey, Kingsport, TN (US); John Thomas Hofmann, Kingsport, TN (US)

(73) Assignee: Eastman Chemical Company, Kingsport, TN (US)

(21) Appl. No.: 15/387,069

(22) Filed: Dec. 21, 2016

(51) Int. Cl. E04C 2/02; B32B 27/20; B32B 27/36; B32B 37/06; E04C 2/06; E04C 2/14

(52) U.S. Cl. CPC E04C 2/02; B32B 27/20; B32B 27/36; B32B 37/06; B32B 2419/04; E04C 2/14; B32B 2318/00; B32B 2305/076; B32B 2315/08; E04C 2/06

(57) ABSTRACT

The present invention is generally directed to prepreg composites, typically in the form of unidirectional tapes, which contain at least one reinforcing fiber and a thermoplastic polyester matrix. The prepreg composites can be thermally bonded to a mineral-containing substrate in order to improve the performance characteristics of the substrate without requiring adhesives and without significantly increasing the mass or thickness of the substrate. The prepreg composite of the present invention can be applied to a wide range of mineral-containing substrates, including structural panels, gypsum wallboards, plasterboard, drywall, cement boards, or ceiling tiles.

### BACKGROUND

### Field of the Invention

The present invention is generally related to prepreg composites comprising a thermoplastic polymer and the application of such composites onto mineral-containing substrates. More particularly, the present invention is generally related to unidirectional tapes comprising a thermoplastic polyester and the application of such tapes onto mineral-containing substrates useful as building and construction panels and boards.

### Description of the Related Art

This present invention provides structural reinforcement for mineral-containing building or construction panels by using fiber-reinforced thermoplastic layers. Specifically, thin thermoplastic-based reinforcing layers are shown to make improvements to the performance characteristics of building and construction panel substrates without substantially increasing the substrate thickness and without the need of an additional bonding agent (adhesive).

Reinforcement can include increases to mechanical and structural properties such as stiffness or strength (e.g. flexural), impact or crack resistance, nail or fastener pull-out resistance, sag resistance, friability resistance, and more.

Efforts to improve the performance of building panels via the addition of fortifying layers typically require adhesives or significantly increase the thickness of the panel. EP2743075A1 and EP2743077A1 detail the addition of various lamina, including both reinforced and unreinforced layers, to the face of gypsum panels, with the use of adhesives.

US20080110111A1 discloses a prefabricated element for buildings that utilizes either anchoring projections or an adhesive to attach a fiber-reinforced skin to a core element.

U.S. Pat. No. 3,350,257A discloses the adhesive lamination of thin plastic sheet to gypsum wallboard.

Finally, US20010300386A1 discloses a construction sheathing panel that includes a laminate affixed to a more rigid board with liquid adhesive bonding.

Despite the previous efforts to produce a building panel with improved structural integrity and handleability, there still exists a need for technology that substantially improves structural integrity and handleability of building panels, without (A) adding significant thickness or weight and (B) without requiring adhesives or bonding agents. This invention provides a technology and process to substantially improve the structural integrity of building panels, as well as other performance attributes, with a minimal increase in panel thickness (<5%) and without the use of bonding adhesives.

### SUMMARY

One aspect of the present invention comprises a reinforced mineral-containing substrate comprising: a thermoplastic reinforcing layer bonded onto at least one surface of a mineral-containing substrate, wherein said thermoplastic reinforcing layer comprises at least one thermoplastic polymer and at least one reinforcing fiber.

One aspect of the present invention comprises a method for preparing a reinforced mineral-containing substrate, said method comprising: bonding a prepreg composite directly onto at least one surface of a mineral-containing substrate to thereby form said reinforced mineral-containing substrate; wherein said bonding forms a direct bond between said prepreg composite and said substrate surface, and wherein said prepreg composite comprises at least one thermoplastic polyester and at least one reinforcing fiber.

Another aspect of the present invention comprises a reinforced mineral-containing substrate comprising: a unidirectional tape thermally bonded onto at least one surface of a mineral-containing building panel substrate, wherein said unidirectional tape has a thickness of 0.1-2.0 mm and comprises at least one thermoplastic polyester and at least one reinforcing fiber, wherein said reinforcing fiber is glass and comprises 10-80% by weight of the thermoplastic reinforcing layer, wherein said building panel substrate has a thickness of 1-40 mm and comprises structural panels, gypsum boards, gypsum panels, gypsum wallboards, plasterboard, drywall, wallboards, high density boards, hard boards, impregnated boards, water repellant boards, cement boards, ceiling panels or ceiling tiles, wherein said thermoplastic polyester has a melt phase viscosity in the range of 10³ to 10⁸ Pa-s at 30 to 250° C. and is amorphous with a glass transition temperature of at least 50° C., and wherein said polyester comprises:

an acid component comprising at least 50 mole percent of terephthalic acid (TPA), isophthalic acid (IPA), 1,3- or 1,4-cyclohexane dicarboxylic acid (CHDA), napthalenedicarboxylic acid, stilbenedicarboxylic acid or mixtures thereof; and a diol component comprising at least 25 mole percent of ethylene glycol (EG), 1,4-cyclohexanedimethanol (CHDM), Diethylene glycol (DEG), 2,2,4,4, tetramethyl-1,3 cyclobutanediol (60 mol % cis isomer) (TMCD), 1,2-propanediol, 1,3-propanediol, neopentyl glycol, 1,4-butanediol, 1,5-pentanediol, 1,6-hexanediol, or p-xylene glycol or mixtures thereof, wherein the acid component is based on 100 mole percent of total acid residues in the copolyester and the diol component is based on 100 mole percent of total diol residues in the copolyester.

### BRIEF DESCRIPTION OF THE DRAWING

FIG. 1 shows the load profile generated as a function of strain for the flexural tests and illustrates the improvements with the addition of the UDT reinforcing layer.

### DETAILED DESCRIPTION

The present invention may be understood more readily by reference to the following detailed description of certain embodiments of the invention and the working examples.

One embodiment of the present invention provides a thin fiber-reinforced thermoplastic layer bonded directly to a mineral-containing building and construction panel substrate for the purpose of modifying the performance characteristics of the substrate without substantially changing the size or mass of the construction panel substrate. This invention provides substrates such as gypsum wallboard, cement board, and ceiling tiles with significant improvements in structural and mechanical properties such as ease of handling, moisture resistance, stiffness or strength (e.g. flexural), impact or crack resistance, nail or fastener pull-out resistance, sag resistance, and friability resistance.

One embodiment of the present invention provides a reinforced mineral-containing substrate comprising: a thermoplastic reinforcing layer bonded onto at least one surface of a mineral-containing substrate, wherein said thermoplastic reinforcing layer comprises at least one thermoplastic polymer and at least one reinforcing fiber.

Another embodiment of the present invention provides a method for preparing a reinforced mineral-containing substrate, said method comprises bonding a prepreg composite directly onto at least one surface of a mineral-containing substrate to thereby form said reinforced mineral-containing substrate; wherein said bonding forms a direct bond between said prepreg composite and said substrate surface, and wherein said prepreg composite comprises at least one thermoplastic polyester and at least one reinforcing fiber.

One aspect of the present invention relates to prepreg composites, such as unidirectional tapes, long fiber tapes (“LFT”), and short fiber tapes (“SFT”). In some embodiments the prepreg composites can be bonded to mineral-containing substrates in order to enhance various performance properties of the substrate. As discussed herein, the prepreg composites generally comprise a thermoplastic polyester that allows the composite to be bonded to the mineral-containing substrate without the need for adhesives. By eliminating the need for adhesives, in bonding the prepreg composites to the mineral-containing substrates, this can simplify the application process and mitigate costs in producing reinforced mineral-containing substrates. Consequently, the prepreg composites described herein can offer compelling value for reinforcing mineral-containing panels and substrates in markets such as building and construction. Furthermore, the use of the prepreg composite described herein yield lightweight reinforced substrates.

In some embodiments, prepreg composites comprising long fiber tapes have fibers 4 mm to 6 mm in length in the final reinforcing tape and prepreg composites comprising short fiber tapes have fibers 2 mm to 4 mm in length in the final reinforcing tape.

### The Prepreg Composite

As used herein, a “prepreg” refers to a composite comprising at least one reinforcing fiber impregnated with a resin matrix formed from at least one thermoplastic polymer. The prepreg composite can be in the form of a tape, plate, or panel.

The composite can include discontinuous reinforcing fibers, continuous reinforcing fibers, or mixtures thereof. The fibers may be aligned preferentially in one or more directions, or be randomized in directional alignment to yield quasi-isotropic response.

Discontinuous fibers can include any reinforcing fiber with a finite cut length that overall is random in alignment, aligned in one direction, or combinations thereof. Discontinuous fiber cut length can vary according to desired processing, performance, and other attributes. For maximum performance enhancement it is desirable to maintain a cut fiber length that is near or greater than the critical fiber length. For example, critical fiber length for discontinuous parallel fiber lamina can be represented by:

$${l}_{c} = \frac{σ {f}_{u}}{2 {τ}_{i}} {d}_{f}$$

With σ_{fu} the ultimate fiber strength, l_{c} the minimum fiber length required for maximum fiber stress to be equal to the ultimate fiber strength at the midlength, τᵢ the shear strength of the fiber matrix interface, and d_{f} the fiber diameter.

Aligned, or parallel discontinuous fibers will result in anisotropic properties with modulus and strength being largest in the direction of fiber alignment. In the case of randomly oriented discontinuous fibers the lamina will exhibit planar isotropic behavior. In this case the properties will be uniform in the plane of the lamina but reduced from the aligned fiber lamina (fiber direction).

Continuous fiber-reinforced thermoplastics include continuous parallel fiber lamina often referred to as unidirectional tape (UDT). UDTs comprise a band of continuously aligned reinforcing fibers which is impregnated within a matrix resin. Often fiber alignment and laminate design (multiple lamina or tape layers) are manipulated for stress/strain management.

In certain embodiments, the prepreg composite comprises a unidirectional tape wherein the reinforcing fibers are unidirectionally aligned. Consequently, due to their specific alignment, the reinforcing fibers in the tapes can be arranged parallel, perpendicular, or at an angle (e.g., 30°, 45°, or 60°) to the substrate when bonded onto the substrate.

Whether discontinuous or continuous fiber constructions, single or multiple layers, it is important to consider the total thickness of the reinforcing layer(s), especially in relation to the substrate. This invention will highlight reinforcing layers on the order of 0.014 inches (0.36 mm) and substrates on the order of 0.25-0.60 inches (6.4-15.2 mm).

In various embodiments, the prepreg composite can comprise at least 10, 15, 20, 25, 30, 35, 40 and up to 85, 80, 75, 70, or 65 weight percent of at least one reinforcing fiber. For example, the prepreg composite can comprise in the range of 10 to 85, 10 to 80, 10 to 75, 10 to 70, 10 to 65, 10 to 40, 15 to 85, 15 to 75, 15 to 70, 15 to 65, 20 to 85, 20 to 80, 20 to 75, 20 to 70, 20 to 65, 25 to 85, 25 to 80, 25 to 70, 25 to 65, 30 to 85, 30 to 80, 30 to 75, 30 to 65, 35 to 80, 35 to 65, 40 to 80, 40 to 75 or 40 to 65 weight percent of at least one reinforcing fiber.

Suitable reinforcing fibers can include, for example, glass, carbon, flax, metal, basalt, boron, commingled fibers, polymers, high molecular weight polyethylene, aramid, or mixtures thereof. Suitable glass fibers can include, for example, S-glass, E-glass, or R-glass.

In various embodiments, the thermoplastic polymer in the prepreg composites comprises a thermoplastic polyester. The thermoplastic polyesters can be prepared using melt phase or solid state polycondensation procedures that are known in the art. Examples of these processes are described in U.S. Pat. No. 2,901,466, U.S. Pat. No. 4,539,390, and U.S. Pat. No. 5,633,340, the disclosures of which are incorporated herein by reference in their entireties.

In one or more embodiments, the prepreg composite can comprise at least 15, 20, or 30 or up to 90, 80, 75, 70, 65, 55, or 40 weight percent of at least one thermoplastic polyester. For example, the prepreg composite can comprise in the range of 15 to 90, 15 to 80, 15 to 75, 15 to 65, 15 to 55, 15 to 40, 20 to 90, 20 to 80, 20 to 75, 20 to 65, 20 to 55, 20 to 40, 30 to 90, 30 to 80, 30 to 75, 30 to 65, 30 to 55 or 30 to 40 weight percent of at least one thermoplastic polyester.

It should be noted that “thermoplastic” polymers are different from “thermosetting” polymers. “Thermosetting” polymers, also known as “unsaturated” polymers, are generally materials that are cured or harden into a given shape through the application of heat, which can form various crosslinks within the material. The hardened or cured thermosetting materials will not generally remelt and regain the processability that they had prior to being hardened or cured. In contrast, “thermoplastic” polymers soften (i.e., become pliable) when heated, but do not cure or set. A thermoplastic often begins in pellet form and becomes softer and more fluid as heat increases. This fluidity allows these materials to be applied using a different array of methods. Furthermore, due to the absence of chemical curing, the changes in the thermoplastic are generally physical and, with the reapplication of heat, partially or wholly reversible. A thermoplastic polymer can typically be reprocessed many times, which is a major reason why thermoplastic-based composite prepregs are compelling for a number of markets and applications. The thermoplastic polyesters utilized in the present invention can provide many benefits over conventional thermoset polymers including, for example, faster fabrication (i.e., reduced cycle time), increased recyclability, better formability, and improved mechanical properties.

In certain embodiments, the thermoplastic polyester can have a melt phase, zero-shear viscosity in the range of 10³ to 10⁷ Pa-s at 30 to 250° C. or 10³ to 10⁶ Pa-s at 30 to 250° C.

Depending on the desired application, the thermoplastic polyester can comprise an amorphous polyester, a semi-crystalline polyester, or a crystalline polyester. Additionally, in various embodiments, the thermoplastic polyester can have a glass transition temperature (“T_{g}”) of at least 25, 50, 60, 75, 90, 100, or 125° C. or up to 150, 200, 225, or 250° C. For example, the thermoplastic polyester can have a Tg in the range of 25 to 250° C., 25 to 225° C., 50 to 200° C., or 50 to 150° C.

Furthermore, in some embodiments where the thermoplastic polyester is a crystalline polyester, the thermoplastic polyester can have a melting temperature (“Tm”) of at least 50, 75, 100, 125, 150, 175, or 200° C. or up to 150, 200, 225, or 250° C. For example, the thermoplastic polyester can have a Tm in the range of 25 to 250° C., 25 to 225° C., 50 to 200° C., or 50 to 150° C. In certain embodiments, the thermoplastic polyester includes polyesters that are initially amorphous in the prepreg composite, but become at least partially crystallized after being thermally bonded onto the mineral-containing substrate.

The thermoplastic polyester useful for the prepreg composites comprises an acid component and a diol component.

The acid component of the thermoplastic polyester can comprise various types of acids. In various embodiments, the acid component comprises aromatic dicarboxylic acids having 8 to 14 carbon atoms, aliphatic dicarboxylic acids having 4 to 12 carbon atoms, cycloaliphatic dicarboxylic acids having 8 to 12 carbon atoms, or mixtures thereof. In one or more embodiments, the acid component comprises terephthalic acid, isophthalic acid, 1,4-cyclohexane dicarboxylic acid (“CHDA”), naphthalenedicarboxylic acid, stilbenedicarboxylic acid, cyclohexanediacetic acid, diphenyl-4,4′-dicarboxylic acid, succinic acid, glutaric acid, adipic acid, azelaic acid, sebacic acid, or mixtures thereof.

In some embodiments, the acid component comprises at least 10, 25, 50, 75, 90, 95, or 99 mole percent of terephthalic acid, isophthalic acid, CHDA, naphthalenedicarboxylic acid, stilbenedicarboxylic acid, or mixtures thereof. The component percentages recited herein for the acid component and the diol component are based on the mole percentage for each acid or diol in the respective component and the total mole percentage of the combined monomers in the components cannot exceed 100 mole percent. In certain embodiments, the acid component comprises 100 mole percent of terephthalic acid, isophthalic acid, CHDA, naphthalenedicarboxylic acid, stilbenedicarboxylic acid, or mixtures thereof.

In one or more embodiments, the acid component comprises at least 10, 25, 50, 75, 90, 95, or 99 mole percent of terephthalic acid, isophthalic acid, CHDA, or mixtures thereof. In certain embodiments, the acid component comprises 100 mole percent of terephthalic acid, isophthalic acid, CHDA, or mixtures thereof.

In one or more embodiments, the acid component comprises at least 10, 25, 50, 75, 90, 95, or 99 mole percent of terephthalic acid, isophthalic acid, or mixtures thereof. In certain embodiments, the acid component comprises 100 mole percent of terephthalic acid, isophthalic acid, or mixtures thereof. Furthermore, in certain embodiments, the acid component is comprised entirely of terephthalic acid and/or isophthalic acid. Moreover, in certain embodiments, the acid component is comprised entirely of terephthalic acid. Alternatively, in certain embodiments, the acid component is comprised entirely of isophthalic acid. In one or more embodiments, the acid component comprises 100 mole percent CHDA.

The diol component of the thermoplastic polyester can comprise various types of diols. In various embodiments, the diol component comprises 2,2,4,4-tetramethyl-1,3-cyclobutanediol (“TMCD”), 1,4-cyclohexanedimethanol (“CHDM”), ethylene glycol, diethylene glycol, 1,2-propanediol, 1,3-propanediol, neopentyl glycol, 1,4-butanediol, 1,5-pentanediol, 1,6-hexanediol, or p-xylene glycol, or mixtures thereof.

In one or more embodiments, the diol component comprises at least 1, 5, 10, 15, 20, 25, 30, or 40 and/or not more than 99, 90, 75, 65, 55, or 50 mole percent of TMCD, CHDM, ethylene glycol, diethylene glycol, or mixtures thereof. For example, the diol component can comprise in the range of 1 to 99, 5 to 90, 10 to 75, 15 to 75, 25 to 75, 30 to 75, 40 to 75, 1 to 55, 5 to 55, 1 to 50, or 5 to 50 mole percent of TMCD, CHDM, ethylene glycol, diethylene glycol, or mixtures thereof.

In one or more embodiments, the diol component comprises less than 60, 50, 40, 30, 20, 10, 5, or 1 mole percent of ethylene glycol. Alternatively, in some embodiments, the diol component comprises at least 0.5, 1, 2, 5, 10, 15, 20, 25, 30, or 40 mole percent of ethylene glycol. In certain embodiments, the diol component can comprise in the range of 0.5 to 50, 0.5 to 40, 1 to 30, 1 to 20, 20 to 40 or 25 to 35 mole percent of ethylene glycol. In some embodiments, the diol component can comprise can comprise up to 99 mole percent or 100 mole percent of ethylene glycol.

In one or more embodiments, the diol component comprises TMCD and CHDM. For example, the diol component can comprise at least 1, 5, 10, 15, 20, 25, 30, or 40 or up to 99, 90, 75, 65, 55, or 50 mole percent of TMCD and CHDM. Generally, in various embodiments, the diol component can comprise in the range of 1 to 99, 5 to 99, 5 to 90, 10 to 75, 15 to 65, 20 to 55, 25 to 55, 30 to 50, or 40 to 99 mole percent of TMCD and CHDM.

In one or more embodiments, the diol component comprises CHDM. For example, the diol component can comprise at least 5, 25, 35, 40, 45, 50, or 60 or up to 99, 90, 85, 80, 75, or 70 mole percent of CHDM. Generally, in various embodiments, the diol component can comprise in the range of 5 to 99, 25 to 90, 35 to 85, 40 to 80, 45 to 75, 50 to 75, 50 to 70, or 60 to 99 mole percent of CHDM. Alternatively, in certain embodiments, the diol component can comprise at least 40, 45, 50, 55, 60, 65, 70, 75, 80, 85, 90, 95, or 99 mole percent of CHDM. In some embodiments, the diol component can comprise 100 mole percent of CHDM.

In one or more embodiments, the diol component comprises TMCD. For example, the diol component can comprise at least 5, 25, 35, 40, 45, 50, or 60 or up to 99, 90, 85, 80, 75, or 70 mole percent of TMCD. Generally, in various embodiments, the diol component can comprise in the range of 5 to 99, 25 to 90, 35 to 85, 40 to 80, 45 to 75, 50 to 75, 50 to 70, or 60 to 99 mole percent of TMCD. Alternatively, in certain embodiments, the diol component can comprise at least 40, 45, 50, 55, 60, 65, 70, 75, 80, 85, 90, 95, or 99 mole percent of TMCD.

In one or more embodiments, the diol component comprises diethylene glycol. For example, the diol component can comprise at least 1, 5, 10, 20, or 30 or up to 95, 80, 70, 60, or 45 mole percent of diethylene glycol. Generally, in various embodiments, the diol component can comprise in the range of 1 to 95, 5 to 80, 10 to 70, 20 to 60, or 30 to 45 mole percent of diethylene glycol.

In addition to the reinforcing fibers and the thermoplastic polyester, the prepreg composite can comprise less than 10, 5, 2, or 1 weight percent of one or more additives. Suitable additives can include, for example, antioxidants, denesting agents, impact modifiers, antiblocking agents, metal deactivators, colorants, phosphate stabilizers, mold release agents, fillers such as talc and mica, silica, glass beads, nucleating agents, ultraviolet light and heat stabilizers, lubricants, flame retardants, or mixtures thereof. Alternatively, in certain embodiments, the prepreg composite can contain no additives. The prepreg composite can be formed using methods known in the art, which can include, for example, a pultrusion-type process. Such production methods are further described in U.S. Pat. No. 4,549,920, U.S. Pat. No. 4,559,262, U.S. Pat. No. 5,094,883, U.S. Pat. No. 6,709,995, and U.S. Pat. No. 7,297,740, the contents of which are incorporated herein by reference in their entireties.

### Methods of Applying the Prepreg Composite

The prepreg composite can be directly applied onto a selected surface of a mineral-containing substrate to thereby form the reinforced mineral-containing substrate. As used herein, “directly applied” means that no adhesive is present between the selected surface of the mineral-containing substrate and the prepreg composite. An “adhesive,” as used herein, refers to adhesives typically used to apply prepreg composites onto substrates including, for example, epoxy resins, phenol resorcinol, formaldehyde resorcinol, melamine or cross-linked melamine, PVA or cross-linked PVA, isocyanate, polyurethane, and urea-based adhesives. However, as discussed further below, this exclusion of adhesives does not exclude the presence of thermoplastic resin layers between the selected surface of the mineral-containing substrate and the prepreg composite. These thermoplastic resin layers are described later in greater detail.

In some embodiments, the selected surface on which to apply the prepreg composite can comprise an external surface of the mineral-containing substrate. The external surface can be, for example, the outside surface of the mineral-containing substrate.

In some embodiments, the prepreg composite can be thermally bonded onto the selected surface of the mineral-containing substrate in a process that involves applied heat and pressure for a certain amount of time. In various embodiments, the prepreg composite can be applied onto the mineral-containing substrate by heating the prepreg composite to form a heated prepreg composite and then contacting the heated prepreg composite with the selected surface of the mineral-containing substrate. Alternatively, in various embodiments, the prepreg composite can be applied onto the mineral-containing substrate by heating the selected surface of the mineral-containing substrate and then contacting the prepreg composite with the heated surface. In other alternative embodiments, both the prepreg composite and selected surface of the mineral-containing substrate can be heated prior to contacting the composite and substrate surface.

In one or more embodiments, the heating and contacting steps can occur simultaneously. Alternatively, in certain embodiments, the prepreg composite and selected surface of the mineral-containing substrate can first be contacted with each other and then heated in order to apply the prepreg composite onto the selected surface.

Generally, in such embodiments, the prepreg composite and/or selected surface of the mineral-containing substrate can be heated to temperatures in the range of 30 to 300° C. In one or more embodiments, the heating occurs at temperatures of at least 30, 50, 75, 100, or 150° C. or up to 300, 250, 225, 215, 205, 195, or 185° C. Similarly, the heating can occur at temperatures in the range of 30 to 250° C., 30 to 225° C., 50 to 215° C., 50 to 150° C., 75 to 205° C., 100 to 195° C., or 150 to 250° C. In most embodiments, the temperature during the application process should be kept at temperatures below 300° C. because the polymers may undergo undesirable reactions temperatures above 300° C. when in the presence of air (oxygen). It should be noted that the heat can come from conductive heating, convective heating, infrared heating, and/or heating derived from radio frequencies.

Additionally, in various embodiments, the melting temperatures (Tₘ) and the glass transition temperatures (T_{g}) of the polyester can determine the most appropriate temperatures needed to bond the prepreg composite to the substrate.

In embodiments where the polyester is an amorphous polyester, the bonding temperatures should occur at temperatures ranging from the glass transition temperature of the polyester up to 300° C. For example, the bonding for amorphous polyesters can occur in the range of T_{g}+25° C., T_{g}+50° C., or T_{g}+75° C., as long as these ranges are under 300° C.

In embodiments where the thermoplastic polyester is a crystalline polyester or a semi-crystalline polyester, the bonding temperatures occur at temperatures exceeding the melting temperatures of the polyester, but still at a temperature not exceeding 300° C. For example, the bonding for crystalline polyesters can occur in the range of Tₘ+25° C., Tₘ+50° C., or Tₘ+75° C., as long as these ranges are under 300° C.

It should be noted that the above heating temperatures refer to the temperatures that the polyester component in the prepreg composite reaches during the heating process and does not refer to the temperatures of the application apparatuses. Thus, the apparatuses used to apply the heat and bond the prepreg composite to the mineral-containing substrate can operate at temperatures higher than those indicated above in order to provide the necessary thermal energy to the prepreg composite. Such application apparatuses can include, for example, a hydraulic press, a static press, a roll laminator, a double belt laminator, infrared lamps, press platens, or a high pressure chamber.

The contacting step between the prepreg composite and the selected surface of the mineral-containing substrate can occur at pressures of at least 0.01, 0.03, 0.1, 0.25, 0.30, 0.35, 0.50, 0.75, or 1.0 or up to 5.0, 4.0, 3.4, 3.0, 2.5, 2.0, or 1.75 MPa. For example, the contacting step can occur at pressures in the range of 0.03 to 3.40 MPa, 0.25 to 5.0 MPa, 0.30 to 4.0 MPa, 0.34 to 3.4 MPa, 0.35 to 3.0 MPa, 0.17 to 2.5 MPa, 0.50 to 2.5 MPa, 0.75 to 2.0 MPa, or 1.0 to 1.75 MPa. This pressure can be supplied, for example, by a hydraulic press, static press, roll laminator, or high pressure chamber. In some embodiments, higher pressures can break or damage the substrate.

In one aspect of the present invention, the thermal bonding or thermocompression process requires a combination of applied heat and pressure for some amount of time. The type of substrate and thermoplastic polymer used may impose some upper limits on what temperatures can be used. Similarly, in some embodiments, the amount of pressure applied must be below a certain level to prevent damage to certain types of substrate.

In certain embodiments, the pressure can be applied after the initial contact between the prepreg composite and the selected surface of the mineral-containing substrate.

The above heating and pressure steps can occur for at least 1, 2, 3, 4, 5, 6, 7, 8, 9, or 10 minutes or up to 60, 50, 45, 30, 20, or 15 minutes. For example, the heating step and/or pressure step can occur over a time period in the range of 1 to 60 minutes, 1 to 10 minutes, 1 to 7 minutes, 1 to 5 minutes, 2 to 10 minutes, 2 to 5 minutes, 2 to 7 minutes, 3 to 10 minutes, 5 to 10 minutes, 6 to 15 minutes, or 7 to 20 minutes. In such embodiments, the pressure utilized for the contacting step during these longer residence times can be in the range of 0.03 to 3.40 MPa, 0.25 to 5.0 MPa, 0.30 to 4.0 MPa, 0.34 to 3.4 MPa, 0.35 to 3.0 MPa, 0.17 to 2.5 MPa, 0.50 to 2.5 MPa, 0.75 to 2.0 MPa, or 1.0 to 1.75 MPa. It should be noted that these ranges refer to the amount of time that the prepreg composite is at the desired temperature and pressure.

Alternatively, the heating step and/or pressure step can occur over a very short period of time when continuous press technology, such as roll presses, double belt press laminators, and other continuous style equipment, is utilized. For example, the above heating and pressure steps can occur for at least 0.01, 0.05, 0.1, or 0.5 and/or not more than 25, 20, 10, or 5 seconds. More particularly, the above heating and pressure steps can occur over a time period in the range of 0.01 to 25, 0.05 to 20, 0.1 to 10, 0.01 to 10, 0.1 to 10, or 0.5 to 5 seconds. In such embodiments, higher pressures may be utilized during these shorter residence times to facilitate the bonding between the prepreg composite and the mineral-containing substrate. For example, the pressure utilized for the contacting step during these shorter residence times can be in the range of 1 to 10 MPa, 1 to 5 MPa, 2 to 12 MPa, 2.5 to 11 MPa, 3 to 10 MPa, 3.5 to 9.5 MPa, 3.5 to 9 MPa, or 4 to 8.5 MPa.

As noted above, in various embodiments, no adhesive is present or used between the prepreg composite and the selected surface of the reinforced mineral-containing substrate. Once applied, the prepreg composite can form a direct bond with the selected surface of the mineral-containing substrate.

### Resin Layers

Additionally, in certain embodiments, a thermoplastic resin layer can be applied onto the selected surface of the mineral-containing material prior to applying the prepreg composite in order to reduce the processing temperature and/or pressure in the formation of the bond between the prepreg composite and mineral-containing material. Furthermore, since the resin layer can enable a stronger bond to the substrate, the use of such layers may reduce the prepreg composite bonding time necessary to obtain the desired strengths and properties in the substrates. Moreover, when lamination equipment is used to apply the prepreg composite and resin layers, the use of the resin layers may enable the use of lower pressures and/or temperatures during thermal bonding in order to reach the desired bond strength.

It should be noted that these “thermoplastic resin layers” are not adhesives since they can be formed from thermoplastic polymers, including the same thermoplastic polyesters used to produce the prepreg composites. Consequently, the resin layers can be applied to the selected surface of the mineral-containing substrate utilizing the same application methods described above for the prepreg composites. The resulting mineral-containing substrate containing a resin layer applied thereon can be considered a “pre-reinforced substrate” on which the prepreg composite can be applied. Alternatively, in certain embodiments, the resin layers may be applied to the surface of the mineral-containing substrate at the same time as the prepreg composite.

In various embodiments, the resin layer can comprise, consist essentially of, or consist of at least one thermoplastic polymer. These thermoplastic polymers can comprise any of the thermoplastic polyesters described above in regard to the prepreg composite. In one or more embodiments, the resin layer can comprise at least 50, 75, 95, or 99 weight percent of one or more thermoplastic polyesters.

In certain embodiments, the resin layer can contain the same thermoplastic polyester as used in the prepreg composite. Alternatively, the resin layer can contain at least one thermoplastic polyester that is not present in the prepreg composite.

The resin layers can comprise one or more additives. The additives can comprise, for example, antioxidants, denesting agents, impact modifiers, antiblocking agents, metal deactivators, colorants, phosphate stabilizers, mold release agents, fillers such as talc and mica, silica, glass beads, glass fibers, nucleating agents, ultraviolet light and heat stabilizers, lubricants, flame retardants, or mixtures thereof.

### The Substrates

Mineral-containing refers to materials that are composed mainly of natural occurring substances that have crystal structures and are usually solid. Included in this definition are groups of minerals (two or more) which together can form more complex substances such as rocks or stones. These materials are typically inorganic and can be used in many forms, including but not limited to fibers and sheets. Gypsum, perlite, magnesium oxide, calcium silicate, vermiculite, cement, and mineral wool and mixtures thereof are a few examples of mineral-containing substances suitable for use in the building and construction panels and substrates useful in the present invention. Suitable materials may also be synthetic such as glassy type by-products from ore processing. It is important to note that mineral-containing panels and substrates often include additives and other components that provide function or aesthetic benefits such as for example cellulose, starch, waxes, or coatings.

Building or construction panels/boards may include many different types of products and materials and among these are included gypsum board, cement board, and ceiling tiles. Building panels can be used in both interior and exterior constructions and in some cases provide the primary means of structural integrity. Building or construction panels or boards suitable for use in the present invention include, for example, structural panels, gypsum boards, gypsum panels, gypsum wallboards, plasterboard, drywall, wallboards, high density boards, hard boards, impregnated boards, water repellant boards, cement boards, ceiling panels or ceiling tiles.

Gypsum board, also referred to as drywall or wallboard, is typically composed of a calcium sulfate based core sandwiched between layers of paper facing. Gypsum board comes in many varieties including standard, predecorated, backing, shaftliner, foil lined, and more. These different varieties incorporate various additives or designs to meet certain application demands. Gypsum board is used commonly in the construction of walls and ceilings for both residential and commercial structures and can be used either as a backing material or as a surfacing material.

Cement board, like gypsum board, is used in the construction of walls, floors, countertops, and other areas and is often chosen when an advanced level of moisture resistance is desired. Unlike standard gypsum board, which can lose integrity in water contact or high moisture and humidity conditions, cement board typically maintains its structure under high humidity and water-contact situations.

Ceiling tiles come in different varieties and often provide both acoustical performance and interior finish. Among the various material construction options are cellulose or mineral fibers such as those produced from rock or slag. Tiles are also classified according to patterns, edges, and more.

While gypsum board and cement board both provide rigid constructions when expertly fastened to underlying structures (studs, baseboards, etc.), transportation and installation can provide challenges since both gypsum and cement board are heavy and relatively brittle products. For example, half-inch thick standard gypsum board has a weight of approximately 2.0 lbs./ft², meaning that a standard 4 ft.×8 ft. panel can weigh upwards of 60 pounds. Similarly, half-inch thick cement board has a weight of approximately 2.9 lbs./ft², meaning that a standard 4 ft.×8 ft. panel can weight upwards of 90 pounds. Large panels such as these often require multiple people for transport and installation, or special equipment to hold and position the panels. Additionally, small deflections/bends due to transient loads incurred during transport and installation can result in cracks that render the panels as unusable or scrap. Finally, once installed these panels can be weak in impact and durability, having inadequate indentation and abrasion resistance, or deficient in other characteristics that result in cracking, holes, tears, and other losses in board integrity.

Lay-in ceiling tiles are different from gypsum and cement boards in that they are not typically heavy nor do they support significant loads. Ceiling tiles, however, do present challenges due to their relatively friable and brittle nature which can be problematic during shipping, handling and installation.

One way to quantify the brittle aspect of construction panels (including cement, gypsum, and ceiling tiles), as outlined in ASTM C1185, is the handleability index (U) defined as:

$$U = \frac{0.5 \cdot P \cdot Δ}{t}$$

With P=break (also failure or peak) load, Δ=ultimate deflection, and t=thickness. Accordingly, the units for the handleability index are in·lbf/in or mm·N/mm. The handleability index represents a measure of the ability of the material to be handled without breaking. This is an important characteristic for transport, installation and more. An increase in the handleability index means an increase in the ease of handling. As an example, increasing the load to failure for a given panel thickness and ultimate deflection will result in an increase in the handleability index.

In some embodiments of the present invention, it may be necessary to keep the bonding temperature and exposure time such that no significant changes occur either within the substrate or within the thermoplastic polymer. For example, finished gypsum panels exposed to temperatures greater than 150° C. can undergo dehydration or calcination reactions. These reactions can lead to both chemical and physical changes within the gypsum board that result in a loss of board integrity. Similarly, some polymers may start to undergo undesirable reactions at temperatures above 300° C. when in the presence of air (oxygen). As such, in one aspect of the present invention, the upper temperature for bonding should not be higher than 300° C. In another aspect of the present invention, the polymers contained in the fiber-reinforced thermoplastic layers should be resins with melt-phase, zero-shear viscosities of 10³-10⁸ Pa·s. In one embodiment, the viscosities should be in the range of 10³-10⁶ Pa·s.

In general, adhesion to mineral-based building panels will be improved with more polar thermoplastics due to their increased ability to wet the substrate surface. Increased wetting of the substrate surface should, in general, lead to greater opportunity for direct bonding. One measure of polarity for polymers is the surface energy, where the larger the energy the more polar the molecule. Polyolefins are usually described as having low polarity and have surface energies typically in the range of 30-35 mN/m; polyamides and polyesters, frequently deemed as highly polar, have surface energies typically in the range of 45-50 mN/m. Suitable thermoplastics for this invention include those polymers that have surface energies in the range of 30-50 mN/m or 40-50 mN/m.

In some embodiments, suitable thermoplastics include, for example, polymers such as polypropylene, polyethylene, polystyrene, polyvinylchloride, polyamides, polyesters, acrylics, and polycarbonate.

In some embodiments, the thermoplastic polyester reinforcing layers were found to exhibit high gloss, semi-transparency, and contact clarity after being thermally bonded to various building panels and substrates. This may be useful in some applications as it enables the bonded surface to show through to the observer, thereby offering functional and aesthetic advantages.

Additionally, the layers formed from the prepreg composites can be semi-transparent and/or exhibit desirable gloss. In embodiments where the prepreg composite is applied to an external surface of the mineral-containing material, the external surface upon which the prepreg composite is applied can have a gloss in the range of at least 40 as measured according to ASTM D 2457.

The reinforced materials produced with the prepreg composites described herein can be utilized in various applications in the building and construction industry, or any other industry in which mineral-containing materials are utilized. The reinforced materials can be incorporated into various end products including, for example, interior walls, exterior walls, ceilings, partitions, elevator shafts, stair wells subroofing materials, concrete form panels, reinforcement panels.

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

This invention can be further illustrated by the following examples of embodiments thereof, although it will be understood that these examples are included merely for the purposes of illustration and are not intended to limit the scope of the invention unless otherwise specifically indicated.

### EXAMPLES

### Polymer Resins

Table 1 summarizes a list of the polymers evaluated. The polymers include copolyesters that are combinations of one or more diols and acid monomers. Examples P1 and P2 contain about 69 mol % ethylene glycol (EG), and about 31 mol % 1,4-cyclohexanedimethanol (CHDM), and 100 mol % terephthalic acid (TPA). These materials differ in the fact that the molecular weight (or IhV) varies marginally and P1 contains carbon black colorant (P1). Other polyesters include P3 and P4, which are based on additional monomer combinations as noted in the Table, containing glycols such as: ethylene glycol (EG), 1,4-cyclohexanedimethanol (CHDM), diethylene glycol (DEG), and tetramethyl-1,3 cyclobutanediol (60 mol % cis isomer), as well as terephthalic acid (TPA). The detail of each polymer composition examined are reported in the Table 1, which also includes information on the polymer IhV, glass transition temperature (T_{g}), melting temperature (Tₘ) or “A” indicating the sample is amorphous with no measurable melting temperature, and typical percent crystallinity both before and after bonding. T_{g} values for the polyamide and polypropylene materials were estimated and not measured. Morphologies: Case 1 is a material which is amorphous and does not crystallize thereby allowing it to thermally bond between T_{g} and Tₘ. Case 2 is a semicrystalline material which starts as mostly amorphous but which can crystallize during thermal bonding and still be bonded between T_{g} and Tₘ. Case 3 includes highly crystalline materials which require exceeding the Tₘ to be thermally bonded to inorganic-based building panels. Table 1 also shows the non-polyester materials evaluated. These resins include polyamide 6 (PC1) and polypropylene (PC2).

### Reinforcing Layers

Table 2 is a summary of the reinforcing layers that were produced from the polymers listed in Table 1 and used in the evaluations. Within this table are unidirectional tape (UDT) samples and also discontinuous fiber reinforcing layers. The unidirectional tape samples (UDTs) in both cases were produced using the processes as described above. For the glass UDT samples, 13 micron diameter E-glass fiber was used and for the carbon UDT samples, 7 micron fiber was used. Chopped short-glass samples were prepared using twin-screw compounding resin (P2) with chopped glass fiber 13 microns in diameter, which were then extruded into a film, using a single-screw Killion extruder. Chopped long-glass samples were prepared by extruding previously made long-fiber pellets (via a proprietary pultrusion process) into a film, using the same single-screw extruder; glass fiber diameter in this case was 17 microns. Table 2 also lists the weight fraction of fiber (the remaining fraction being polymer), fiber type and fiber length. The reinforcing layer thickness is highlighted, and the morphology case is listed. Average fiber length was measured qualitatively from ashed samples.

TABLE 1
Polyester and non-polyester resins
(with “P” representing polyester resins and “PC” representing non-
polyester polymers.
Polyester Materials

| | Diols | | | Acid | | | | % Crystallinity | |
|---|---|---|---|---|---|---|---|---|---|
| Polymer | mol % | mol % | mol % | mol % | IhV | T_{g} | Tₘ | (Before-After | Morphology |
| ID # | EG | CHDM | TMCD | TPA | (dL/g) | (° C.) | (° C.) | Bonding) | Case |
| P1* | 69 | 31 | 0 | 100 | 0.55 | 77 | A | amorphous | Case 1 |
| P2 | 69 | 31 | 0 | 100 | 0.58 | 78 | A | amorphous | Case 1 |
| P3 | 0 | 77 | 23 | 100 | 0.63 | 106 | A | amorphous | Case 1 |
| P4 | 96 | 4 | 0 | 100 | 0.56 | 78 | 243 | 5-30 | Case 2 |

Non-polyester Materials

| | | Estimated | | % Crystallinity | |
|---|---|---|---|---|---|
| Polymer | | T_{g} | Tₘ | (Before-After | Morphology |
| ID # | Description | (° C.) | (° C.) | Bonding) | Case |
| PC1 | Polyamide 6: Radilon S 24E | 50 | 220 | 23-27 | Case 3 |
| PC2 | Polypropylene: PPH-10060 | −20 | 165 | 43-46 | Case 3 |

*Polymer contained black colorant

TABLE 2
Thermoplastic reinforcing layers

| | | | Fiber | | | |
|---|---|---|---|---|---|---|
| | | | Loading | | | |
| Reinforcing | | Fiber | by Mass | | Layer Thickness | Morphology |
| Layer ID | Polymer | Type | (%) | Fiber Length | (μm) | Case |
| C1 | P2 | Glass | 60 | Continuous | 330-390 | Case 1 |
| C2 | P1 | Glass | 60 | Continuous | 330-390 | Case 1 |
| C3 | P3 | Glass | 60 | Continuous | 330-390 | Case 1 |
| C4 | P4 | Glass | 60 | Continuous | 330-390 | Case 2 |
| C5 | P1 | Carbon | 42 | Continuous | 330-390 | Case 1 |
| C6 | P2 | Glass | 40 | Long | 330-390 | Case 1 |
| | | | | chopped* | | |
| C7 | P2 | Glass | 20 | Long | 330-390 | Case 1 |
| | | | | chopped* | | |
| C8 | P2 | Glass | 20 | Short | 330-390 | Case 1 |
| | | | | chopped** | | |
| C9 | PC1 | Glass | 67 | Continuous | 330-390 | Case 3 |
| C10 | PC2 | Glass | 64 | Continuous | 330-390 | Case 3 |

| | | | | |
|---|---|---|---|---|
| C11 | P2 | Unfilled | 225-275 | Case 1 |

*Average fiber length = 3 mm
**Average fiber length = 0.3 mm

### Building Panels

The mineral-containing building panels evaluated include the commercial products as described below.

Gypsum Wallboard: Standard grade drywall was used; the matrix below shows measured values for the different gypsum wallboard types (two varieties of ½″ wallboard were used).

| Gypsum Wallboard | Weight Per Area | Density |
|---|---|---|
| Thickness | (lb/ft²/kg/m²) | (lb/ft³/kg/m³) |
| ¼″ (6.35 mm) | 1.18/5.76 | 47/907 |
| ⅜″ (9.53 mm) | 1.42/6.94 | 43/728 |
| ½″ (12.70 mm) | 1.51/7.38 | 36/581 |
| ½″ (12.70 mm) | 1.26/6.15 | 30/484 |

Cement Board: HardieBacker® cement-fiber board underlayment ¼″ thick with a weight per area of 1.90 lb/ft² was used for all cement board evaluations. In metric units this corresponds to 6.35 mm thickness with a weight per area of 9.27 kg/m², and density of 1461 kg/m³. This product is described by the manufacturer as 90% Portland cement and sand, and 10% cellulose fibers and proprietary additives to enhance performance.

Ceiling Tile: Radar™ Basic (wet-formed mineral fiber substrate) ceiling tiles were used. The panels were classified as Type III, Form 2, Pattern C, and E according to ASTM E1264. The tiles were 0.60″ in thickness with an areal weight of 0.70 lb/ft². In metric units this corresponds to a thickness of 15.24 mm, areal weight of 3.42 kg/m², and density of 224 kg/m³.

### Description of Characterization Methods

### Measurement of Inherent Viscosity (IhV)

As used, herein the term inherent viscosity (or IhV) is the viscosity of a dilute solution of the polymer, specifically IhV is defined as the viscosity of a 60/40 (wt %/wt %) phenol/tetrachloroethane at a concentration of 0.25 g polyester per 50 ml solution at 25° C. or 30° C. This viscosity measurement is representative of the polymer's molecular weight.

### Measurement of Zero-Shear Viscosity (ηₒ)

The zero-shear viscosity (ηₒ) of the polymer matrix, where reported, was determined by first capturing small amplitude oscillatory shear (SAOS) rheology data using a Rheometrics RDA II rheometer and performing frequency sweeps over the range of 1 to 400 s⁻¹ at multiple temperatures above the T_{g} for a given polymer of known composition and IhV. For each polymer of a known IhV, at least three frequency sweeps were conducted at different temperatures above the T_{g}. Once the data were obtained, a Cross model was fit and the terms were modeled as follows:

$$η ( T , Ih V , \dot{γ} ) = \frac{{η}_{o}}{1 + {( τ \dot{γ} )}^{m}}$$

$${η}_{o} = A 1 {( T - 80 )}^{A 2} Ih {V}^{A 3}$$

$$τ = A 4 {( T - 80 )}^{A 5} Ih {V}^{A 6}$$

$$m = A 7 {( T - 80 )}^{A8} Ih {V}^{A 9}$$

The fitting terms, A1-A9 were determined by well-known regression methods, and a model was then used to estimate the film zero-shear viscosity at the time of lamination—using lamination temperature (T) and the known polymer inherent viscosity (IhV) as inputs.

### Measurement of Polymer Thermal Properties

The melting point temperatures (Tₘ) and glass transition temperatures (T_{g}) of the polymers, where reported, were determined using a TA Q2000 DSC instrument from Thermal Analyst Instruments at a scan rate of 20° C./min according to ASTM D3418. The samples were heated from 23° C. to 280° C. (20° C./min). After annealing for 2 minutes at 280° C., the samples were quenched and a second heat melting scan was performed at the same 20° C./min rate. The reported melting point temperature (Tₘ) is the peak minimum of the endothermic heat flow curve of the second heat melting scan, whereas the reported glass transition temperature (T_{g}) is determined from the midpoint of the enthalpy step change in the scan, prior to the melting temperature.

Crystalline content was measured using the same DSC instrument and procedure. Absolute and relative percent crystallinity values were calculated using the observed enthalpies of crystallization and melting and also the reference heat of fusion value for polyethyleneterephthalate.

### Measurement of Glass Fiber Content

Glass fiber content of the fiber-reinforced layers was determined by weighing residual material after ashing. This was completed by measuring the mass of a tape sample using an analytical balance. The sample was then placed within a muffle furnace (Thermolyne™ 4800 or equivalent) with a temperature control of 600+/−10° C. for a period of 2 hours. The residual mass of the tape sample after ashing was subsequently measured using an analytical balance. The percent glass fiber content was determined by the ratio of the final to the original sample mass. Please note that samples of at least 1.5 g were utilized to minimize error.

### Methods Used for Evaluation of Various Substrates

The methods of sample preparation and testing for both methods are described in detail below:

### Method of Sample Preparation for Gypsum Wallboard

Drywall substrates were prepared using ¼″, ⅜″, or ½″ thick standard gypsum wallboard obtained from a commercially available retailer. These substrates were cut to the proper dimensions required for flexural strength, humidified deflection, nail pull resistance, moisture transmission, and impact test methods. A 10″ Lift Tilt Contractor's Saw was utilized to cut the majority of the appropriately-sized samples for each required test method. Directionality was maintained for the samples within each group to help minimize variability of results. All ½″ and ⅜″ flexural testing used gypsum specimens prepared in the machine direction while ¼″ flexural testing used specimens prepared in the transverse direction.

Test samples were prepared by thermal bonding and lamination. A Carver® brand press (Model #3693) was utilized to produce all the gypsum samples in this study, except those used for the humidified deflection tests. The press was equipped with dual-opening, 14″ by 14″ (0.36 by 0.36 m) steel platens, independent digital temperature controllers, applied hydraulic force of up to 60,000 lb_{f} (267 kN), and an integrated water coolant system. The parameter adjustable for each sample included the bonding time of 1-7 minutes, the lamination temperature of 120-250° C., and the holding pressure of 25-75 psi (0.17-0.51 MPa). Samples that were cooled were done so under pressure for a period of 2 minutes. Each flexural test specimen containing a tape embedded with continuous fibers was configured such that the fiber direction was the same as the length of the sample. For discontinuous glass fiber composite films, the films were applied such that the roll direction of the film was the same as the major direction of the drywall board.

Roll lamination was used as an alternate processing technique to prepare some of the examples. A standard roll press with a heated top roll and bottom rubber roll (not heated) was utilized. Specifically, the machine involved a Black Brothers Inc. Rotary Pneumatic Press, RPP-C1575, which had two drums of 15.75″ (0.40 m) diameter and were 56″ (1.42 m) wide. The top roll was a double-shell spiral baffle construction with a reinforced PTFE-based release surface with 1″ hot oil rotary joints for oil heating. The bottom combining/rubber roll was constructed of 60 Durometer EPDM. Line speed could be varied between approximately 12 and 24 feet per minute (3.7-7.4 m/min). Reinforcing layers were placed directly on ambient temperature drywall board and run through the press at various line speeds. In samples where two layers of reinforcing layers were used the layers were placed one on top of each other and run through the rotary press only once. Heat for direct bonding was applied only via the heated top roll. The thermoplastic reinforcing layer was preheated to approximately 191° C. prior to passing through the laminating rolls. Surface temperature of the heated roll was measured as 207-210° C. Gap setting was leveled at about ½″ (12.7 mm), the thickness of the gypsum panel substrate.

### Method of Sample Preparation for Cement Board

Cement board samples were prepared starting with ¼″ (6.35 mm) thick HardieBacker® cement-fiber board. The cement board was cut to desired dimensions using a straight edge as a guide along with a scoring knife.

Direct-bonded samples were prepared by thermal bonding using the aforementioned Carver® brand press. The parameters utilized for the thermoplastic samples included a bonding (heat applied) time of 1 minute, a platen temperature of 160-250° C. and a holding pressure of 150 psi (1.02 MPa). To help distribute load and facilitate release, a 0.10″ (2.54 mm) thick silicone mat was used between the hot platen and the bonding surface. For all samples the bonding (heating) time was followed by a 1 minute cooling time during which the load was maintained. After the cooling cycle the samples were removed from the press and allowed to equilibrate at room temperature. Direct bonding of continuous fiber samples was such that the fiber direction was the same as the main sample direction (length). Although a platen press method was used for the cement board evaluations, other methods of applying a consolidation force and elevated temperature are also suitable for use, including roll press systems.

Adhesively bonded specimens were prepared using Liquid Nails® FRP-310 bonding mastic recommended for adhering fiberglass reinforced plastic panels to gypsum, cement board, and more. This adhesive contains an ethylene/vinyl acetate copolymer and is filled with limestone and kaolin. The adhesive was troweled onto the cement board smooth surface and the UDT was applied and consolidated under light pressure. The adhesive was allowed to set for one week before testing. Adhesive bonding of continuous fiber samples was such that the fiber direction was the same as the main sample direction (length).

### Method of Sample Preparation for Ceiling Tiles

Ceiling tile samples were prepared starting with panels of 0.60″ (15.24 mm) thickness and 2 ft.×4 ft. (˜600 mm×1200 mm) in area. The ceiling tile was cut to desired dimensions using a straight edge as a guide along with a scoring knife.

Direct-bonded samples were prepared by placing the reinforcing layers onto the surface of the ceiling tile, inserting the layered structure into a polymer bag, and vacuum sealing the bag. The sealed bag was placed into an oven at a prescribed temperature for a period of 1 minute. The bagged sample was removed from the oven, allowed to cool to room temperature, and then opened to produce the laminated sample. Direct bonding of continuous fiber samples was such that the fiber direction was the same as the main sample direction (4 ft. length). In all cases bonding was on the back surface of the ceiling tile. A vacuum compaction method was used to direct bond to the ceiling tiles. Although a vacuum compaction method was used in these trials, other methods of applying a consolidation force also should be feasible, including both the static platen press and continuous roll lamination press systems described previously.

### Measurement of Flexural Strength: 3-Point Bending Test Method

For the flexural strength analysis of building panels using reinforcements via composite layers a 3-point bending test method was used, as described by ASTM D790. In all cases a universal testing machine (UTM) was used for bending tests.

For gypsum, cement, and ceiling tile panels various configurations of substrates and reinforcing layers were used and measured using the 3-point bending test method. Mechanical data were acquired by 3-point bending using a span-to-thickness ratio of 16:1 or 24:1 for platen-pressed gypsum drywall, 14:1 for roll laminated gypsum drywall, 16:1 for cement board, 14:1 for ceiling tile, and a crosshead displacement speed of 0.10 inches per minute (2.54 mm/min) for all substrates. The samples were positioned such that the reinforcing layer was on the bottom face of the sample being tested, unless otherwise noted. Samples that contained unidirectional fiber reinforcing layers had the fiber direction parallel to the sample span. The resulting ultimate flexural strength, a σᵤₗₜᵢₘₐₜₑ, was calculated according to equation (1), where P is the load at failure (peak load), L is the test span, b is the sample width, and d is the sample thickness (substrate+reinforcing layer):

$${σ}_{ultimate} = \frac{3 PL}{2 {bd}^{2}}$$

In a similar manner deflection (D) and flexural strain (ε_{f}) at ultimate strength were collected/calculated. These qualities are related according to equation:

$$D = \frac{{L}^{2} {ɛ}_{f}}{6 d}$$

### Calculation of Handleability Index

Handleability index (U), as described in ASTM C1185, was calculated based on the results of the flexural strength testing using:

$$U = \frac{0.5 \cdot P \cdot Δ}{t}$$

With P=flexural breaking/failure load, Δ=ultimate deflection, and t=sample thickness. Note that in this equation thickness is represented by “t” while in flexural testing thickness is represented by “d”. For substrates that had small differences in sample widths the calculation was normalized to give values per unit width (in·lb_{f}/in·in or mm·N/mm·mm). Ultimate deflection was recorded as the maximum center point deflection value corresponding to the failure load.

### Measurement of Nail Pull Resistance

A test in accordance with ASTM C473 was used to quantify nail pull resistance. This test reports the peak load required to push a nail head through the surface of a piece of drywall, as is or with the reinforcing layers applied. ½″ or ¼″ thick drywall samples containing different qualities of reinforcing layers on the face or back surface were tested and are reported. For the testing a 7/64″ (2.78 mm) diameter pilot hole was drilled through the center of a 6″ by 6″ (˜150 by 150 mm) gypsum wallboard sample and an aluminum nail head was set flush on its face surface. The aluminum nail met the requirements specified in ASTM C473. The universal testing machine used to verify flexural strength was modified by attaching a plunger to the movable cross head. The plunger applied a force on the nail head causing it to break through the surface of the sample This maximum force was recorded as the peak load (N or lb_{f}).

### Measurement of Humidified Sag Resistance

Sag resistance was quantified using a humidified deflection procedure in accordance with ASTM C473. Gypsum wallboard samples 1 ft.×2 ft. (˜300 mm×600 mm) were cut in the machine direction from full-size panels, with and without reinforcing composite tape, and placed into a humidity chamber. The boards were conditioned for 48 hours in a humidity chamber set at 90° F. (32° C.) and 90% relative humidity and the sag depth was recorded. The span length for the boards was 23 in. (584 mm) between bearing edges. Sag depth was defined as the distance from a level surface derived from the wallboard ends to the top of the conditioned gypsum panel. In the reinforced example the composite tape was applied to the back surface of the gypsum panel and this surface was placed on the bearing edges.

### Measurement of Impact Resistance

Impact resistance for reinforced and standard gypsum wallboard was quantified using an indentation test procedure outlined in ASTM D5420. A 4 lb (1.82 kg) weight was dropped via a guided tube from 18″ (0.46 m) in elevation above the wallboard surface onto different configurations of 4″ by 4″ (˜100 by 100 mm) samples. The striker diameter for this testing was 0.5″ (12.7 mm). In all cases the weight impacted the face surface of the drywall panel. The dent depth into the sample surface due to the falling weight was measured using a Mitutoyo digital depth gauge.

### Measurement of Moisture Absorption

Moisture absorption was measured on standard gypsum wallboard and reinforced gypsum wallboard with one layer of UDT direct bonded to the back surface of the board. The gypsum samples, approximately 2″ by 2″ (˜50 by 50 mm) by thickness (½″), were placed atop a saturated sponge that was placed in a tray of deionized water. The sponge surface area in contact with the panel was slightly less than the drywall samples so that water transmission was only through the major face of the gypsum panel (and not the edges). Water and ambient temperature were held constant at 23° C. Direct contact of the sponge was to the back surface of the gypsum samples. Samples remained in contact with the saturated sponge for 24 hours and periodic mass measurements were made to monitor the mass gained. Free surface water was wiped away before mass measurements. Normalized mass factor was calculated as the mass of the gypsum sample at a certain time divided by the mass before moisture contact.

### Description of Results

For ease of interpretation, the presentation of results is broken into discrete sections designed to clearly articulate the features, benefits, limitations, and claims of this invention. Note that “Control” is used within the Tables to denote panel samples that did not have any reinforcing layers applied; these samples were used as the basis for property comparisons.

### Gypsum Wallboard

### Gypsum Panel Flexural Performance

### Examples 1-13 Reinforced Layers Based on Case 1 Polymers Bonded to ½″ Gypsum Wallboard

Examples 1-13 were bonded using a platen-style Carver press for a period of 5 minutes and at pressure of 75 psi. All bonding took place on the back surface of ½″ thick drywall boards, boards that had a weight per area of 1.26 lb/ft². Flexural tests for Tables 4 and 5 utilized a span-to-thickness ratio of either 24:1 or 16:1. Property “Increase” is defined as the difference between the example and the appropriate control sample values divided by the appropriate control sample value. “COV” is defined as the relative standard deviation, given as the ratio of example standard deviation to example average. Fiber direction for Examples 1-13 was in the machine direction of the gypsum wallboard and a cooling period of 2 minutes under load was utilized.

TABLE 3
Flexural strength results for layers bonded to ½″ gypsum wallboard.

| | | | | | Viscosity at | | | |
|---|---|---|---|---|---|---|---|---|
| | | | Span-to- | Bonding | Bonding | Flexural | | Strength |
| | Reinforcing | | thickness | Temperature | Temperature | Strength | COV | Increase |
| Example | Layer ID | Description | Ratio | [° C.] | (Poise) | [MPa] | [%] | [%] |
| 1 | Control A | — | 24:1 | — | — | 6.2 | 0 | — |
| 2 | C3 | P3-Glass-UDT | 24:1 | 120 | 3.4 × 10⁸ | No adhesion developed | | |
| 3 | C3 | P3-Glass-UDT | 24:1 | 160 | 2.6 × 10⁶ | 9.2 | 12 | 48 |
| 4 | C3x2 | P3-Glass- | 24:1 | 160 | 2.6 × 10⁶ | 8.3 | 8 | 34 |
| | | UDT(2) | | | | | | |
| 5 | C2 | P1-Glass-UDT | 24:1 | 120 | 1.5 × 10⁷ | 11.3 | 4 | 82 |
| 6 | C2x2 | P1-Glass- | 24:1 | 120 | 1.5 × 10⁷ | 11.7 | 6 | 89 |
| | | UDT(2) | | | | | | |
| 7 | C1 | P2-Glass-UDT | 24:1 | 120 | 2.0 × 10⁷ | 12.6 | 3 | 100 |
| 8 | C1x2 | P2-Glass- | 24:1 | 120 | 2.0 × 10⁷ | 13.1 | 5 | 111 |
| | | UDT(2) | | | | | | |
| 9 | Control B | — | 16:1 | — | — | 5.8 | 7 | — |
| 10 | C1 | P2-Glass-UDT | 16:1 | 150 | 7.5 × 10⁵ | 10.1 | 3 | 74 |
| 11 | C6 | P2-Glass-LFT | 16:1 | 150 | 7.5 × 10⁵ | 7.4 | 10 | 28 |
| 12 | C7 | P2-Glass-LFT | 16:1 | 150 | 7.5 × 10⁵ | 7.9 | 1 | 36 |
| 13 | C8 | P2-Glass-SGF | 16:1 | 150 | 7.5 × 10⁵ | 7.4 | 5 | 28 |

TABLE 4
Flexural modulus results for layers bonded to ½″ gypsum
wallboard.

| | | | Span-to- | Bonding | Flexural | | Modulus |
|---|---|---|---|---|---|---|---|
| | Reinforcing | | thickness | Temperature | Modulus | COV | Increase |
| Example | Layer ID | Description | Ratio | [° C.] | [MPa] | [%] | [%] |
| 1 | Control A | — | 24:1 | — | 1794 | 7 | — |
| 2 | C3 | P3-Glass- | 24:1 | 120 | No adhesion developed | | |
| | | UDT | | | | | |
| 3 | C3 | P3-Glass- | 24:1 | 160 | 2741 | 13 | 53 |
| | | UDT | | | | | |
| 4 | C3x2 | P3-Glass- | 24:1 | 160 | 2708 | 2 | 51 |
| | | UDT(2) | | | | | |
| 5 | C2 | P1-Glass- | 24:1 | 120 | 2914 | 3 | 62 |
| | | UDT | | | | | |
| 6 | C2x2 | P1-Glass- | 24:1 | 120 | 3368 | 4 | 88 |
| | | UDT(2) | | | | | |
| 7 | C1 | P2-Glass- | 24:1 | 120 | 3435 | 1 | 92 |
| | | UDT | | | | | |
| 8 | C1x2 | P2-Glass- | 24:1 | 120 | 3686 | 7 | 106 |
| | | UDT(2) | | | | | |
| 9 | Control B | — | 16:1 | — | 2105 | 3 | — |
| 10 | C1 | P2-Glass- | 16:1 | 150 | 3030 | 6 | 44 |
| | | UDT | | | | | |
| 11 | C6 | P2-Glass- | 16:1 | 150 | 2501 | 1 | 19 |
| | | LFT | | | | | |
| 12 | C7 | P2-Glass- | 16:1 | 150 | 2421 | 1 | 15 |
| | | LFT | | | | | |
| 13 | C8 | P2-Glass- | 16:1 | 150 | 2213 | 4 | 5 |
| | | SGF | | | | | |

### Examples 14-15 Non-Reinforced Layer Based on Case 1 Polymer Bonded to ½″ Gypsum Wallboard

Example 15 is a counter-example showing unreinforced P2 thermoplastic polymer bonded to gypsum board at 150° C. using the same conditions and materials otherwise as outlined in Examples 10-13. Example 14 was a control (unreinforced) sample used for comparison. Both these examples utilized a span-to-thickness ratio of 16:1.

TABLE 5
Flexural strength and modulus results for non-reinforced
thermoplastic layer bonded to ½″ gypsum wallboard.

| | | | Flexural | | Strength | Flexural | | Modulus |
|---|---|---|---|---|---|---|---|---|
| | Reinforcing | | Strength | COV | Increase | Modulus | COV | Increase |
| Example | Layer ID | Description | [MPa] | [%] | [%] | [MPa] | [%] | [%] |
| 14 | Control | — | 6.2 | 7 | — | 1806 | 10 | — |
| 15 | C11 | P2-Unfilled | 6.4 | 7 | 3 | 1676 | 2 | −7 |

Results in Tables 3 through Table 5 show a significant improvement in terms of strength and modulus due to the direct bonding of the reinforcing layers based on Case 1 polymers. Increases in flexural strength are most significant for reinforcing layers that contain continuous glass fiber (34-111% increase). Strength gains for the discontinuous samples were also significant (28-36% increase) while application of an unfilled polymer layer alone (C11 in Example 15) did not provide a significant improvement in strength. Similarly, modulus gains were most significant for reinforcing layers with continuous fiber (44-106% increase) and modest for samples with discontinuous (5-19% increase) glass fiber incorporation. Application of a non-reinforcing thermoplastic layer resulted in a decrease in modulus. Finally, only a slight improvement (106% versus 92%, as shown by Examples 7-8) was observed when two layers of reinforcing layers were used compared to a single layer, and this was mainly in terms of modulus. This trend was observed for all three examples that contained continuous glass fiber. The reason for the marginal enhancement with additional reinforcing layers is believed to be due mainly to the fact that a single layer alone was sufficient to change the failure mode of the drywall from tensile failure on the bottom surface of the test specimen to internal drywall failure. Consequently, further addition of reinforcing layers is not expected to improve the internal strength of the drywall itself.

### Examples 16-18 Unidirectional Tape Layers Based on Case 1 Polymers Bonded to ⅜″ Gypsum Wallboard

Examples 16-18 were bonded using a platen-style Carver press for a period of 5 minutes at 120° C., a consolidation pressure of 75 psi, and a subsequent cooling period of two minutes while under pressure. All bonding took place on the back surface of the drywall board. All gypsum boards were ⅜″ in thickness and had a weight per area of 1.42 lb/ft². Flexural tests in this section utilized a span-to-thickness ratio of 16:1. Fiber direction was in the machine direction of the gypsum wallboard.

TABLE 6
Flexural strength and modulus results for layers bonded to ⅜″
gypsum wallboard.

| | | | Flexural | | Strength | Flexural | | Modulus |
|---|---|---|---|---|---|---|---|---|
| | Reinforcing | | Strength | COV | Increase | Modulus | COV | Increase |
| Example | Layer ID | Description | [MPa] | [%] | [%] | [MPa] | [%] | [%] |
| 16 | Control | — | 7.8 | 5 | — | 2990 | 1 | — |
| 17 | C1 | P2-Glass- | 12.0 | 12 | 54 | 3893 | 10 | 30 |
| | | UDT | | | | | | |
| 18 | C1x2 | P2-Glass- | 12.0 | 9 | 54 | 4377 | 4 | 46 |
| | | UDT (2) | | | | | | |

Results in Table 6 again show a significant improvement in terms of strength and modulus due to the direct bonding of the reinforcing layers. Increases in flexural strength and modulus for the ⅜″ wallboard were of similar magnitude to the improvements seen for the ½″ wallboard. Additionally, only slight improvement was observed when two layers of reinforcing layer C1 were used compared to a unitary layer, and this observation was mainly in terms of modulus.

### Examples 19-30 Reinforcing Layers Applied to ¼″ Gypsum Wallboard Using Case 1, Case 2, and Case 3 Polymers

Examples 19-30, as shown in Table 7, include reinforcing layers based on amorphous and semi-crystalline polyester or non-polyester polymers to demonstrate performance with Case 1, Case 2, and Case 3 matrices. All samples were bonded for a period of 3 minutes using a pressure of 75 psi and cooled under load for 2 minutes, unless otherwise noted. All bonding took place on the back surface of ¼″ drywall board that had a weight per area of 1.51 lb/ft². Flexural testing utilized a span-to-thickness ratio of 16:1. Fiber direction was in the transverse direction of the gypsum wallboard. For the Case 2 and Case 3 polymers the relative polymer crystallinity prior to bonding was measured as 20%, 100% and 100% for P4, PC1 and PC2, respectively. As defined here, relative polymer crystallinity is the ratio of the actual crystalline content to the maximum crystalline content when crystallization is complete. For polymers PC1, PC2 and P4, the maximum crystallization content was measured as 27%, 46%, and 30% respectively. Case 3 polymers had reached their maximum potential crystallinity before lamination while the Case 2 polymer had not reached maximum potential crystallinity before lamination (see Table 1), except for the annealed sample (Example 25). Crystallization is a kinetic process and consequently a semi-crystalline polymer that is quenched from the melt may have a smaller relative crystallinity than the same polymer that is slowly cooled from the melt. A semi-crystalline polymer that has been quenched to mitigate crystallization (i.e. <100% relative crystallinity) can undergo crystallization at temperatures above the glass transition temperature.

TABLE 7
Flexural strength results for reinforcing layers bonded to ¼″ gypsum wallboard.

| | | | | | Relative | | | |
|---|---|---|---|---|---|---|---|---|
| | | | | Viscosity at | Crystallinity | | | |
| | | | Bonding | Bonding | Before/After | Flexural | | Strength |
| | Reinforcing | | Temperature | Temperature | Bonding | Strength | COV | Increase |
| Example | Layer ID | Description | [° C.] | (Poise) | (%) | [MPa] | [%] | [%] |
| 19 | Control | — | — | — | — | 5.1 | 3 | — |
| 20 | C10 | PC2-Glass- | 180 | 1.4 × 10³ | 100/100 | 6.0 | 37 | 16 |
| | | UDT | | | | | | |
| 21 | C10 | PC2-Glass- | 140 | >1 × 10⁸ | 100/100 | No adhesion developed | | |
| | | UDT | | | | | | |
| 22 | C9 | PC1-Glass- | 180 | >1 × 10⁸ | 100/100 | No adhesion developed | | |
| | | UDT | | | | | | |
| 23 | C4 | P4-Glass-UDT | 140 | 1.3 × 10⁶ | 20/100 | No adhesion developed | | |
| 24 | C4 | P4-Glass-UDT | 150 | 4.9 × 10⁵ | 20/100 | Delamination | | |
| | | | | | | upon cooling | | |
| 25 | C4* | P4-Glass-UDT | 150 | 4.9 × 10⁵ | 100/100 | No adhesion developed | | |
| 26 | C4** | P4-Glass-UDT | 150 | 4.9 × 10⁵ | 20/30 | 15.7 | 23 | 208 |
| 27 | C1 | P2-Glass-UDT | 150 | 7.5 × 10⁵ | amorphous | 14.0 | 4 | 175 |
| 28 | C1x2 | P2-Glass- | 150 | 7.5 × 10⁵ | amorphous | 11.8 | 16 | 131 |
| | | UDT(2) | | | | | | |
| 29 | C5 | P1-Carbon- | 150 | 7.5 × 10⁵ | amorphous | 12.2 | 15 | 139 |
| | | UDT | | | | | | |
| 30 | C6 | P2-Glass-LFT | 150 | 7.5 × 10⁵ | amorphous | 9.9 | 9 | 94 |

*Reinforced polymer layer annealed at 170° C. for 5 minutes prior to bonding
**Bonding time 30 seconds followed by immediate quench (no cooling under load)

TABLE 8
Flexural modulus results for reinforcing layers bonded to ¼″
gypsum wallboard.

| | | | | Relative | | | |
|---|---|---|---|---|---|---|---|
| | | | | Crystallinity | | | |
| | | | Bonding | Before/After | Flexural | | Modulus |
| | Reinforcing | | Temperature | Bonding | Modulus | COV | Increase |
| Example | Layer ID | Description | [° C.] | (%) | [MPa] | [%] | [%] |
| 19 | Control | — | — | — | 2337 | 10 | — |
| 20 | C10 | PC2-Glass- | 180 | 100/100 | Not Measured Reliably | | |
| | | UDT | | | | | |
| 21 | C10 | PC2-Glass- | 140 | 100/100 | No adhesion developed | | |
| | | UDT | | | | | |
| 22 | C9 | PC1-Glass- | 180 | 100/100 | No adhesion developed | | |
| | | UDT | | | | | |
| 23 | C4 | P4-Glass-UDT | 140 | 20/100 | No adhesion developed | | |
| 24 | C4 | P4-Glass-UDT | 150 | 20/100 | Delamination upon cooling | | |
| 25 | C4* | P4-Glass-UDT | 150 | 100/100 | No adhesion developed | | |
| 26 | C4** | P4-Glass-UDT | 150 | 20/30 | 3198 | 26 | 37 |
| 27 | C1 | P2-Glass-UDT | 150 | amorphous | 2842 | 9 | 22 |
| 28 | C1x2 | P2-Glass- | 150 | amorphous | 3214 | 2 | 38 |
| | | UDT(2) | | | | | |
| 29 | C5 | P1-Carbon- | 150 | amorphous | 3728 | 5 | 60 |
| | | UDT | | | | | |

*Reinforced polymer layer annealed at 170° C. for 5 minutes prior to bonding
**Bonding time 30 seconds followed by immediate quench (no cooling under load)

Tables 7 and 8 show results for Case 1, Case 2, and Case 3 polymers reinforced with glass fiber.

Case 1 results—Examples 27 through 30—are consistent with the previous tables (for ½″ and ⅜″ drywall) and show a significant increase in flexural strength (94-175%) and modulus (22-60%) with the addition of a reinforcing layer with a Case 1 polymer. Carbon fiber incorporation (C5) gave additional gains in modulus compared to the glass fiber analog (C1). Additionally, the improvements seen for discontinuous fiber were less than those observed for continuous fiber.

Case 2 results—Examples 23-26—showed several important observations. First, attempts to bond at temperatures 140° C. and below were not possible due to the inability to develop sufficient adhesion. Second, bonding at 150° C. (Example 24) was successful but subsequent crystallization of the polymer during the three minute laminating cycle caused a moderate amount of delamination at the gypsum core-face paper interface; the level of delamination was deemed significant enough to exclude this sample from mechanical testing. Third, full crystallization of the reinforcing layer prior to bonding (Example 25) resulted in a lack of adhesion. Finally, significant improvements in strength (208% increase) and modulus (37% increase) were observed when the Case 2 reinforcing layer was bonded for a short time period such that crystallization of the layer was minimized (Example 26).

Case 3 results—Examples 20-22—showed a lack of adhesion for both crystalline polymers when bonding at temperatures between the glass transition and melt (and further limited to 180° C. and below to prevent considerable degradation to the gypsum core, as in Example 21). Adhesion was developed for Example 20 when the temperature was raised above the melting point of the polymer; however, considerable variation was observed in the structural benefits imparted by this layer bonded under these conditions, as noted by a large coefficient of variation. As such, the modulus data for Example 20 cannot be reported reliably in Table 8. While reinforcing layer C10 did provide potential evidence of structural benefits, the magnitude of these benefits did not approach the level of Case 1 and 2 polymers. We believe, without being bound to any theory, that this was due to recrystallization of the reinforcing layer polymer after adhesion was developed, thereby resulting in significant residual stresses in the interfacial region of the face paper and the UDT. These residual stresses can be significant and initiate interfacial failure at the face paper—gypsum core junction, or failure in the gypsum boundary layer adjacent to this interface. The net result of this failure includes regions of delamination, lower structural benefits, and high variability. We also observed that in some cases the level of structural improvements for Case 3 polymers as the matrix resin in reinforcing layers for mineral-containing substrates is dependent on the inherent strength of the substrate material (or interfaces if multilayered) as well as the processing conditions. Therefore, if substrate integrity is improved, then level of structural benefit from Case 3 polymers may increase accordingly. A final point can be made, by Examples 20-21, that much higher temperatures (180° C.) were required to obtain a bond that could be tested. In general, the lower temperature bonding conditions afforded by Case 1 and Case 2 polymers are likely to offer significant practical advantage to reinforcing gypsum wallboard.

Tables 7 and 8 demonstrate improvements achieved by using Case 1 polymersas the matrix in a reinforcing layer direct bonded to gypsum wallboard. Case 1 polymers do not crystallize and therefore no residual stresses are generated due to the volume change that accompanies crystallization. Case 2 polymers, being relatively amorphous prior to bonding, show reinforcing performance if the amount of crystallization incurred during the bonding process is minimized. Case 3 polymers require temperatures approaching or above their respective melt temperature for bonding and then control of the crystallization process such that residual stresses due to volume change are minimized. As is shown in Tables 7 and 8, Case 2 and 3 polymers can be used as reinforcing layers for gypsum if the temperature, time, and cooling are controlled. Nevertheless, Case 1 polymers are more preferred embodiments.

### Examples 31-52 Effects of Bonding Temperature, Time and Cooling for ½″ Gypsum Wallboard Reinforced with Layer C1

Examples 31-52 were prepared by direct bonding reinforcing layer C1 (Case 1 polymer) using a laminating pressure of 75 psi. Laminating temperature, dwell time at pressure and temperature, and cooling time while under pressure were varied for these samples. A cooling time of “0” corresponded to the sample being removed from the press immediately after the laminating step. For samples that incurred cooling chilled water was circulated through the platens at the end of the laminating step and run for 2 minutes, all of this time while under a pressure of 75 psi. All laminations were performed on the back surface of ½″ gypsum wallboard that had a weight per area of 1.51 lb/ft². Span-to-thickness ratio was constant at 16:1 in the flexural tests. Fiber direction was in the machine direction of the gypsum wallboard.

Table 9 shows that in all cases the addition of reinforcing layer C1 resulted in an increase in both flexural strength and modulus. Overall the average increase in both strength and modulus versus the control was 30-90% and 30-80%, respectively. In several instances, as the temperature increased the magnitude of the strength and modulus improvements decreased. Thus, in some instances, this suggests that the temperature should be minimized during direct bonding. For example, flexural strength increased by an average of 63% for samples bonded at 120° C., 55% for samples bonded at 150° C., and 37% for samples bonded at 180° C. Further, flexural modulus increased by an average of 63% for samples bonded at 120° C., 52% for samples bonded at 150° C., and 35% for samples bonded at 180° C. Likewise, in some instances, increasing press time at the higher bonding temperature seemed to negatively impact the magnitude of improvement. Thus, in some instances, this suggests that the time at elevated temperatures should be minimized during the bonding process. In several instances, cooling seems to provide benefits in performance for samples bonded at 120° C. However, this benefit appeared less significant as the bonding temperature was increased to 150° C. and 180° C.

In some embodiments, the conditions for significant improvements in direct bonding thermoplastic reinforcing layers to gypsum wallboard using a static platen pressing method include temperatures of 180° C. or less, bonding times of 1-7 minutes, and pressures less than or equal to 75 psi. In other embodiments, the conditions for significant improvements in platen pressing Case 1 polymers include temperatures of 120-150° C., bonding times 1-5 minutes, cooling times 0-2 minutes, and pressures ≥25 psi but less than the compressive strength of the gypsum wallboard (noted as 350 psi earlier)

TABLE 9
Flexural strength and modulus results as a function of bonding temperature,
and press and cooling time for layer C1 bonded to ½″ gypsum wallboard.

| | | Viscosity at | | | | | | | | |
|---|---|---|---|---|---|---|---|---|---|---|
| | | Bonding | Press | Cooling | Flexural | | Strength | Flexural | | Modulus |
| | Temperature | Temperature | Time | Time | Strength | COV | Increase | Modulus | COV | Increase |
| Example | [° C.] | (Poise) | [min] | [min] | [MPa] | [%] | [%] | [MPa] | [%] | [MPa] |
| 31 | Control | — | — | — | 5.8 | 7 | — | 2105 | 3 | — |
| 32 | 120 | 2.0 × 10⁷ | 1 | 0 | 7.5 | 17 | 29 | 3264 | 1 | 55 |
| 33 | 120 | 2.0 × 10⁷ | 1 | 2 | 9.6 | 12 | 66 | 3549 | 4 | 69 |
| 34 | 120 | 2.0 × 10⁷ | 3 | 0 | 7.8 | 19 | 35 | 3130 | 1 | 49 |
| 35 | 120 | 2.0 × 10⁷ | 3 | 2 | 10.7 | 3 | 85 | 3621 | 1 | 72 |
| 36 | 120 | 2.0 × 10⁷ | 5 | 0 | 9.3 | 4 | 60 | 3426 | 3 | 63 |
| 37 | 120 | 2.0 × 10⁷ | 5 | 2 | 11.2 | 7 | 93 | 3758 | 2 | 79 |
| 38 | 120 | 2.0 × 10⁷ | 7 | 0 | 10.0 | 4 | 72 | 3504 | 8 | 66 |
| 39 | 120 | 2.0 × 10⁷ | 7 | 2 | 9.3 | 0 | 60 | 3212 | 4 | 53 |
| 40 | 150 | 7.5 × 10⁵ | 1 | 0 | 10.3 | 3 | 78 | 3400 | 2 | 62 |
| 41 | 150 | 7.5 × 10⁵ | 1 | 2 | 8.8 | 2 | 52 | 3123 | 7 | 48 |
| 42 | 150 | 7.5 × 10⁵ | 3 | 0 | 10.0 | 3 | 72 | 3439 | 4 | 63 |
| 43 | 150 | 7.5 × 10⁵ | 3 | 2 | 8.7 | 1 | 50 | 3131 | 0 | 49 |
| 44 | 150 | 7.5 × 10⁵ | 5 | 0 | 9.3 | 10 | 60 | 3064 | 11 | 46 |
| 45 | 150 | 7.5 × 10⁵ | 5 | 2 | 9.0 | 2 | 55 | 3199 | 1 | 52 |
| 46 | 150* | 7.5 × 10⁵ | 5 | 2 | 8.9 | 0 | 53 | 3178 | 0 | 51 |
| 47 | 150 | 7.5 × 10⁵ | 7 | 0 | 9.0 | 2 | 55 | 3014 | 0 | 43 |
| 48 | 150 | 7.5 × 10⁵ | 7 | 2 | 6.7 | 1 | 16 | 2478 | 8 | 18 |
| 49 | 180 | 8.3 × 10⁴ | 1 | 0 | 9.2 | 1 | 59 | 3161 | 3 | 50 |
| 50 | 180 | 8.3 × 10⁴ | 1 | 2 | 7.9 | 14 | 36 | 3049 | 7 | 45 |
| 51 | 180 | 8.3 × 10⁴ | 3 | 0 | 7.8 | 1 | 35 | 2909 | 2 | 38 |
| 52 | 180 | 8.3 × 10⁴ | 3 | 2 | 6.9 | 4 | 19 | 2304 | 0 | 9 |

*Tested at 25 psi

### Examples 53-55 Unidirectional Tape Layers Based on Case 1 Polymers Bonded to ½″ Gypsum Wallboard Using Roll Lamination

Examples 53-55 show results for ½″ gypsum wallboard (1.51 lb/ft²) direct bonded with reinforcing layer C2 (Case 1 polymer) using a roll lamination set-up as described earlier. Top roll temperature was measured at approximately 205° C. and line speed was varied between 12-24 feet per minute. All bonding occurred on the back surface of the drywall board. Flexural tested for these examples used a span-to-thickness ratio of 14:1.

Table 10 shows the results for roll lamination using a Case 1 polymer (P1) containing unidirectional glass fiber—reinforcing layer C2. Line speed was varied from 12-24 feet per minute but did not impact performance. As a result, the data at a chosen speed were averaged separately for the one and two-layer configurations. The data in Table 10 shows the performance impact of the reinforcing layer on the gypsum wallboard. Flexural strength and modulus increased significantly (50-60% and 25-31%, respectively). Furthermore, it appeared that adding a second layer of reinforcement only brought minimal improvements as compared to one layer of reinforcement. Additionally, Table 10 shows the strain at peak load values observed for the different samples. Adding polyester-based reinforcing layers increased the strain at which maximum load occurred in all cases. Finally, roll lamination offers certain differences versus standard platen pressing including the potential for short contact times and high output, continuous production. As an example, using a line speed of 12 feet per minute (3.7 m/min) and assuming a contact length of 1.0″ (25.4 mm) for the drywall results in a calculated contact time approaching 0.5 seconds. In addition to faster speed production this approach minimizes excessive heat and time introduced to the drywall, which as shown in Table 9 can have a negative impact on mechanical strength performance.

TABLE 10
Flexural strength and modulus results for samples prepared using heated roll lamination.

| | | | Flexural | | Strength | Failure | | Strain | Flexural | | Modulus |
|---|---|---|---|---|---|---|---|---|---|---|---|
| | Reinforcing | | Strength | COV | Increase | Strain | COV | Increase | Modulus | COV | Increase |
| Example | Layer ID | Description | (MPa) | (%) | (%) | (%) | (%) | (%) | (MPa) | (%) | (%) |
| 53 | Control | — | 6.3 | — | — | 0.6 | — | — | 2848 | — | — |
| 54 | C2 | P1-Glass-UDT | 9.5 | 11 | 51 | 1.8 | 57 | 200 | 3566 | 7 | 25 |
| 55 | C2x2 | P1-Glass-UDT | 10.2 | 5 | 62 | 1.5 | 47 | 150 | 3744 | 14 | 31 |
| | | (2) | | | | | | | | | |

### Gypsum Panel Handleability Index

### Examples 53-55 Reinforced Layers Based on Case 1 Copolyesters Bonded to ½″ Gypsum Wallboard

Handleability index values were calculated for the samples shown in Table 10, which were prepared using a roll laminating process. The calculated values are shown in Table 11 and show an improvement in this measure of a panel's ability to withstand handling without breaking. This improvement is expected as long as a satisfactory bond is obtained between the gypsum panel surface and the reinforcing layer.

TABLE 11
Handleability Index values using roll lamination results.

| | | | | | | | Handleability |
|---|---|---|---|---|---|---|---|
| | Reinforcing | | Peak | Deflection | Handleability | COV | Index Increase |
| Example | Layer ID | Description | Load (N) | (mm) | Index (mm · N/mm) | (%) | (%) |
| 53 | Control | — | 148.1 | 10.0 | 58 | — | — |
| 54 | C2 | P2-Glass- | 222.1 | 29.3 | 254 | 55 | 338 |
| | | UDT | | | | | |
| 55 | C2x2 | P2-Glass- | 238.8 | 24.9 | 231 | 42 | 298 |
| | | UDT (2) | | | | | |

### Gypsum Panel Sag Performance

### Examples 56-57 Reinforced Layer Based on Case 1 Polymer Bonded to ¼″ Gypsum Wallboard

Gypsum panel sag resistance was quantified using a humidified deflection procedure outlined in ASTM C473. Gypsum wallboard ¼″ in thickness was cut into 1 ft.×2 ft. samples from full-size panels in the machine direction to use for the exposure. The sample with reinforcing layer (Example 57) was prepared via roll lamination as outlined in the previous section. The boards were conditioned for 48 hours in a humidity chamber set at 90° F. and 90% relative humidity and the sag depth was recorded. The span length for the boards was 23 inches between bearing edges. Sag depth was defined as the distance from a level surface derived from the wallboard ends to the top of the humidified gypsum panel (occurring at the midpoint location along the span length). In the reinforced example the composite tape was applied to the back surface of the gypsum panel and this surface was placed on the bearing edges. Table 12 shows that one layer of reinforcement nearly eliminated sag for the ¼″ gypsum panel, reduction the sag to only 7% of that for the standard, unreinforced board.

TABLE 12
Humidified sag results for ¼″
gypsum wallboard with and without reinforcement.

| | | | | Sag |
|---|---|---|---|---|
| Exam- | Reinforcing | | Sag Depth | Improvement |
| ple | Layer ID | Description | [mm] | (%) |
| 56 | Control | — | 19.1 | — |
| 57 | C2 | P2-Glass-UDT | 1.3 | 93 |

### Gypsum Panel Nail Pull Resistance

### Examples 58-60 Reinforced Layers Based on Case 1 Polymer Bonded to ¼″ Gypsum Wallboard

A modified version of nail pull resistance as defined in ASTM C473 was used to quantify standard and reinforced gypsum wallboard. For the testing a 7/64″ diameter pilot hole was drilled through the center of a 6″ by 6″ gypsum wallboard sample and an aluminum nail—compliant with ASTM C473—was set flush with the face surface of the drywall panel. A plunger was affixed to the movable crosshead of a universal testing machine and the crosshead moved at a constant rate, thereby pushing the flush nail head into the drywall. The force required for the nail head to break through the surface was recorded as the peak load (lb_{f}). In all cases the nail was pushed through the face side of the gypsum panel. ¼″ thick drywall samples were tested with the reinforcing layer directly bonded to either the face or back surface as noted. Direct bonding conditions included 5 minutes at 75 psi and 120° C. for C1 and 180° C. for 010 (no cooling).

TABLE 13
Nail pull resistance results for ¼″ gypsum wallboard with and
without reinforcement.

| | | | Rein- | | | Peak |
|---|---|---|---|---|---|---|
| | | | forcing | Peak | | Load |
| | Reinforcing | | Layer | Load | COV | Increase |
| Example | Layer ID | Description | Position | [N] | [%] | [%] |
| 58 | Control | — | — | 283.0 | 14 | — |
| 59 | C1 | P2-Glass- | Back | 316.4 | 7 | 12 |
| | | UDT | surface | | | |
| 60 | C1 | P2-Glass- | Face | 376.0 | 4 | 33 |
| | | UDT | surface | | | |

Table 13 shows that nail pull resistance increased via the addition of a copolyester reinforcing layer. Direct bonding the reinforcing layer to the face surface resulted in increased resistance to nail head breakthrough as compared to back surface reinforcement.

### Gypsum Panel Impact Resistance

### Examples 62-64 Reinforced Layers Based on Case 1 Polymer Bonded to ½″ Gypsum Wallboard

Impact resistance for reinforced and standard gypsum wallboard was quantified using an indentation test procedure outlined in ASTM D5420. A 4 lb weight was dropped via a guided tube from 18″ in elevation above the wallboard surface onto different configurations of 4″ by 4″ samples. The striker diameter for this testing was 0.5″. In all cases the weight impacted the face surface of the drywall panel. The dent depth into the sample surface due to the falling weight was measured using a digital depth gauge. Gypsum panel samples used ½″ wallboard (1.51 lb/ft²) that was direct bonding to the reinforcing layer for 5 minutes at 120° C. under 75 psi. Additionally, two minutes of cooling under load were applied after the bonding process.

TABLE 14
Dent depth reduction due to reinforcement of gypsum
wallboard.

| | | | | Dent | | Dent Depth |
|---|---|---|---|---|---|---|
| | Reinforcing | | Reinforcing | Depth | COV | Decrease |
| Example | Layer ID | Description | Layer Position | [mm] | [%] | [%] |
| 62 | Control | — | — | 9.14 | 8 | — |
| 63 | C1 | P2-Glass-UDT | Back surface | 6.86 | 7 | 25 |
| 64 | C1 | P2-Glass-UDT | Face surface | 3.56 | 43 | 61 |

Table 14 illustrates the dent mitigating benefits of the reinforcing layer based on copolyester Case 1 polymer. One thin layer of reinforcement opposite the impactor resulted in a dent reduction of 25% while reinforcement to the side impacted reduced dent depth just over 60%.

### Gypsum Panel Moisture Absorption

### Examples 65-66 Reinforced Layer Based on Case 1 Polymer Bonded to ½″ Gypsum Wallboard

The rate of moisture absorption was measured for a reinforced gypsum panel sample and compared with an unreinforced control. Reinforcing layer C1 was direct bonded to the back surface of ½″ gypsum wallboard (1.51 lb/ft² areal weight) for 5 minutes at 120° C. under 75 psi. Additionally, 2 minutes of cooling under load were applied after the bonding process. Mass gain as a function of time is presented in Table 15 using a normalized mass factor (mass at time t divided by the initial mass). The sample containing the reinforcing copolyester unidirectional tape layer did not gain any mass over the course of the 24 hour exposure while the standard gypsum board sample gained nearly 80% in mass. Clearly the reinforcing layers acts as a moisture barrier preventing the deleterious actions of water on gypsum. Moisture absorption or transmission reduction can be beneficial for building panel applications that require structural integrity while in environments prone to transient moisture loadings (e.g. bathrooms and kitchens). Provided data were generated under liquid water contact to the drywall surface, but benefits are expected to extend to situations that involve periodic contact and/or water vapor movement as well.

TABLE 15
Moisture absorption results for reinforced gypsum wallboard.

| | | | Normalized Mass Factor at Exposure Times | | | |
|---|---|---|---|---|---|---|
| | Reinforcing | | | | | 1440 |
| Example | Layer ID | Description | 0 minutes | 37 minutes | 395 minutes | minutes |
| 65 | Control | — | 1.00 | 1.50 | 1.80 | 1.82 |
| 66 | C1 | P2-Glass-UDT | 1.00 | 1.00 | 1.00 | 1.00 |

### Cement Board

### Cement Board Flexural Performance

### Examples CB1-CB4 Flexural Strength, Modulus, and Failure Strain for Case 1 Polymers Bonded to Cement Board

Cement board studies were conducted using 3 ft.×5 ft. (0.9 m×1.5 m) HardieBacker® EZ Grid® board ¼″ in. thickness. This cement board had a front side with a recessed grid pattern that provided scoring and layout guidance; the back side was featureless and comparatively smooth. Various sample configurations were prepared and tested according to the methods outlined previously. Samples were bonded at 160° C. for 1 minute using a pressure of 150 psi and then cooled for one minute under load, unless otherwise noted. At this bonding temperature, the viscosity for samples CB2 and CB3 was approximately 7.5×10⁵ Poise. Finally, unless noted, cement board samples were prepared such that: The long direction of the cement board coincided with the testing span and reinforcing fiber direction; the reinforcement layer was opposite the side where the flexural load was applied; the reinforcing layer was applied to the back surface (non-grid) of the cement board. Testing conditions included a span of 4 inches (˜100 mm) and crosshead speed of 0.1 in/min (2.54 mm/min).

TABLE 16
Flexural strength results for cement board
with Case 1 polymer reinforcing layers.

| | | | Ultimate | | |
|---|---|---|---|---|---|
| | | | Flexural | | Strength |
| Exam- | Reinforcing | | Strength | COV | Increase |
| ple | Layer ID | Description | (MPa) | (%) | (%) |
| CB1 | Control | — | 12.8 | 5 | — |
| CB2 | C1 | P2-Glass-UDT | 51.6 | 8 | 303 |
| CB3 | C6 | P2-Glass-LFT | 25.2 | 3 | 97 |
| CB4 | C1* | P2-Glass-UDT | 31.7 | 27 | 147 |

*Sample was bonded using adhesive instead of direct thermal bonding as in Example CB2

TABLE 17
Flexural modulus results for cement board
with Case 1 polymer reinforcing layers.

| | | | Flexural | | Modulus |
|---|---|---|---|---|---|
| Exam- | Reinforcing | | Modulus | COV | Increase |
| ple | Layer ID | Description | (MPa) | (%) | (%) |
| CB1 | Control | — | 5981 | 20 | — |
| CB2 | C1 | P2-Glass-UDT | 8296 | 9 | 39 |
| CB3 | C6 | P2-Glass-LFT | 7337 | 5 | 23 |
| CB4 | C1* | P2-Glass-UDT | 7337 | 11 | 23 |

*Sample was bonded using adhesive instead of direct thermal bonding as in Example CB2

TABLE 18
Strain at peak load results for cement board
with Case 1 polymer reinforcing layers.

| | | | Strain at | | Strain |
|---|---|---|---|---|---|
| Exam- | Reinforcing | | Peak Load | COV | Increase |
| ple | Layer ID | Description | (%) | (%) | (%) |
| CB1 | Control | — | 0.33 | 11 | — |
| CB2 | C1 | P2-Glass-UDT | 1.07 | 5 | 224 |
| CB3 | C6 | P2-Glass-LFT | 0.52 | 6 | 58 |
| CB4 | C1* | P2-Glass-UDT | 0.71 | 17 | 115 |

*Sample was bonded using adhesive instead of direct thermal bonding as in Example CB2

Tables 16 through 18 illustrate the significant improvements seen when direct bonding Case 1 based reinforcing layers to cement board. Flexural strength was improved nearly 300% when direct bonding a UDT type of reinforcing layer to the cement board. Additionally, the strength benefit due to direct bonding is evident when comparing Examples CB2 and CB4. Bonding with the aid of an adhesive did result in an increase in flexural strength, but only half of that realized by the direct bonded example (CB2). Flexural modulus increased for all samples (those based on UDT and LFT) but the largest benefit was achieved by direct bonding with the continuous fiber sample. Strain at peak load results followed a similar trend with direct bonded (without adhesive) continuous fiber reinforcement providing the largest increase in values.

### Examples CB5-CB14 Flexural Strength, Modulus, and Failure Strain for Case 2 and 3 Polymers Bonded to Cement Board

TABLE 19
Flexural strength results for cement board with Case 2 and 3
polymer reinforcing layers.

| | | | | Ultimate | | |
|---|---|---|---|---|---|---|
| | | | Bonding | Flexural | | Strength |
| | Reinforcing | | Temperature | Strength | COV | Increase |
| Example | Layer ID | Description | (° C.) | (MPa) | (%) | (%) |
| CB1 | Control | — | — | 12.8 | 5 | — |
| CB5 | C10 | PC2-Glass- | 140 | Did not adhere | | |
| | | UDT | | | | |
| CB6 | C10 | PC2-Glass- | 185 | Did not adhere | | |
| | | UDT | | | | |
| CB7 | C9 | PC1-Glass- | 180 | Did not adhere | | |
| | | UDT | | | | |
| CB8 | C9 | PC1-Glass- | 240 | 25.5 | — | 99 |
| | | UDT | | | | |
| CB9 | C4 | P4-Glass-UDT | 140 | 37.4 | 5 | 192 |
| CB10 | C4** | P4-Glass-UDT | 140 | Did not adhere | | |
| CB11 | C4*** | P4-Glass-UDT | 140 | 36.9 | 8 | 189 |
| CB12 | C4** | P4-Glass-UDT | 180 | Did not adhere | | |
| CB13 | C4 | P4-Glass-UDT | 180 | 35.9 | — | 180 |
| CB14 | C4 | P4-Glass-UDT | 250 | 31.9 | 5 | 149 |

**Annealed at 170° C. for 7 minutes (reached maximum potential crystallinity) prior to lamination
***Heating cycle increased to 5 minutes

TABLE 20
Flexural modulus results for cement board with Case 2 and 3
polymer reinforcing layers.

| | | | Bonding | Flexural | | Modulus |
|---|---|---|---|---|---|---|
| | Reinforcing | | Temperature | Modulus | COV | Increase |
| Example | Layer ID | Description | (° C.) | (MPa) | (%) | (%) |
| CB1 | Control | — | — | 5981 | 20 | — |
| CB8 | C9 | PC1-Glass- | 240 | 6499 | — | 9 |
| | | UDT | | | | |
| CB9 | C4 | P4-Glass-UDT | 140 | 7487 | 1 | 25 |
| CB11 | C4*** | P4-Glass-UDT | 140 | 6527 | 5 | 9 |
| CB13 | C4 | P4-Glass-UDT | 180 | 7962 | — | 33 |
| CB14 | C4 | P4-Glass-UDT | 250 | 6374 | 10 | 7 |

***Heating cycle increased to 5 minutes

TABLE 21
Strain at peak load results for cement board with Case 2 and 3
polymer reinforcing layers.

| | | | | Viscosity at | | | |
|---|---|---|---|---|---|---|---|
| | | | Bonding | Bonding | Strain at | | |
| | Reinforcing | | Temperature | Temperature | Peak Load | | Strain |
| Example | Layer ID | Description | (° C.) | (Poise) | (%) | COV (%) | Increase (%) |
| CB1 | Control | — | — | — | 0.33 | 11 | — |
| CB8 | C9 | PC1-Glass-UDT | 240 | <1.0 × 10³ | 0.81 | — | 145 |
| CB9 | C4 | P4-Glass-UDT | 140 | 1.3 × 10⁶ | 0.69 | 5 | 109 |
| CB11 | C4*** | P4-Glass-UDT | 140 | 1.3 × 10⁶ | 0.68 | 7 | 106 |
| CB13 | C4 | P4-Glass-UDT | 180 | 5.5 × 10⁴ | 0.62 | — | 88 |
| CB14 | C4 | P4-Glass-UDT | 250 | 2.5 × 10³ | 0.82 | 8 | 148 |

***Heating cycle increased to 5 minutes

Tables 19 through 21 show the direct bonding behavior of Case 2 and 3 based reinforcing layers to cement board. Efforts to direct bond the polypropylene-based (PC2) reinforcing layer to cement board using heat were unsuccessful. Efforts to bond polyamide 6 (PC1) at temperatures between its glass transition and melt temperature were unsuccessful. Bonding above the melt temperature of PC1 was possible, but performance improvements were not to the level of the Case 1 polymer results presented previously. Note that because many samples did not bond well as shown in Table 19—modulus, strength, and strain could not be measured in these cases. The polyester Case 2 polymer (P4) was successfully bonded at temperatures within T_{g}-Tₘ and also at temperatures greater than Tₘ. The most significant strength and modulus improvements for this Case 2 based layer were seen at bonding temperatures less than the melting point.

Tables 16-21 summarize the benefits of using Case 1 polymers as the matrix in reinforcing layers bonded to cement boards. Case 1 polymers do not crystallize and therefore no residual stresses are generated during the volume change that accompanies crystallization. Case 2 and 3 polymers also showed reinforcing performance, but not to the same level as that for the Case 1 polymer. Bonding between T_{g} and Tₘ was possible for the polyester-based Case 2 polymer (P4); however, Case 3 polymers (PC1, PC2) required bonding temperatures approaching or above their respective melt temperature.

### Cement Board Handleability Index

### Examples CB1-CB14 Handleability Index Values for Case 1, Case 2, and Case 3 Polymers Bonded to Cement Board

Handleability index values were calculated using peak load and deflection values (reference equations 1 and 2) and are presented in Table 22. Note that since slightly different samples widths were used the peak load was normalized by width.

TABLE 22
Handleability Index values for reinforced cement board.

| | | | Handle- | | Handle- |
|---|---|---|---|---|---|
| | | | ability | | ability |
| | | | Index | | Index |
| Exam- | Reinforcing | | (mm · N/ | COV | Increase |
| ple | Layer ID | Description | mm · mm) | (%) | (%) |
| CB1 | Control | — | 0.25 | 12 | — |
| CB2 | C1 | P2-Glass-UDT | 3.17 | 10 | 1168 |
| CB3 | C6 | P2-Glass-LFT | 0.75 | 7 | 200 |
| CB4 | C1* | P2-Glass-UDT | 1.33 | 32 | 432 |
| CB3 | C9 | PC1-Glass-UDT | 1.19 | — | 376 |
| CB9 | C4 | P4-Glass-UDT | 1.47 | 1 | 488 |
| CB11 | C4*** | P4-Glass-UDT | 2.33 | 8 | 832 |
| CB13 | C4 | P4-Glass-UDT | 1.19 | — | 376 |
| CB14 | C4 | P4-Glass-UDT | 1.49 | 3 | 496 |

*Sample was bonded using adhesive instead of direct thermal bonding as in Example CB2
***Heating cycle increased to 5 minutes

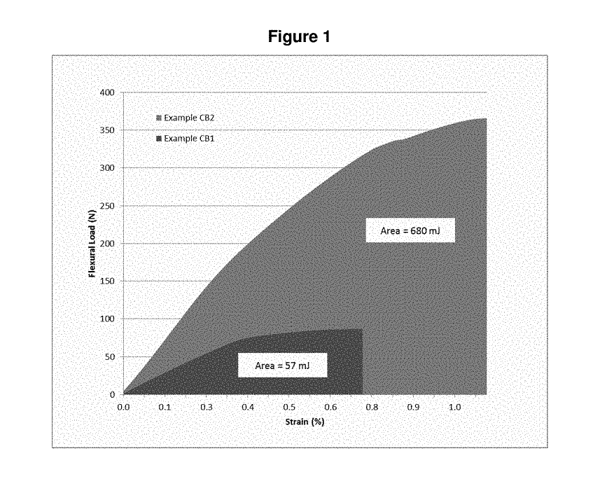

Table 22 illustrates the significant increase in handleability index that occurs when direct bonding a polyester-based unidirectional glass fiber tape to one side of cement board. Both Case 1 and Case 2 polyesters resulted in significant increase to the handleability index. To better illustrate the value afforded by this reinforcing layer FIG. 1 the load profile generated as a function of strain (calculated from displacement) for the flexural tests. Example CB2 (UDT reinforced with Case 1 polymer) is compared to Example CB1 (control) and shows the improvements with the addition of the reinforcing layer. Ultimate flexural load and strain at peak load both are increased, demonstrating the energy consuming benefits given by a single reinforcing layer. Integrating the load—extension responses of these two samples quantifies this benefit: Control integration 57 mJ; UDT reinforced integration 680 mJ, more than 10 times greater than the unreinforced example. Example CB8 illustrates the viability of achieving reinforcement benefit with a Case 3, non-polyester polymer as the matrix. However, the benefit to handleability index is generally not a strong as was found for Case 1 and Case 2 polyester matrices.

### Ceiling Tiles

### Ceiling Tile Flexural Performance

### Examples CT1-CT4 Flexural Strength, Modulus, and Strain at Peak Load for Case 1 and 3 Polymers Bonded to Ceiling Tile

Ceiling tile evaluations were conducted using samples cut from standard 2 by 4 ft. (0.61 m×1.22 m) lay-in ceiling tile. The mineral-containing ceiling tile thickness was 0.6 in. (15.2 mm). Machine direction was defined as the long direction of the commercial ceiling tile and all samples were prepared with this direction coinciding with the test span and reinforcement. Samples were bonded at 155° C. for 1 minute using a consolidation pressure of one atmosphere, unless otherwise noted. At this bonding temperature Examples CT2 and CT3 had polymer viscosities of approximately 3.2×10⁵ Poise. After thermal bonding the samples were allowed to cool via natural convection while remaining under one atmosphere consolidation pressure. Lastly, the reinforcing layer was added to the back surface of the ceiling panel and the flexural load during testing was applied opposite this side. Testing conditions included a span of 8 in. (˜200 mm) and crosshead speed of 0.1 in./min (2.54 mm/min).

TABLE 23
Flexural strength results for reinforced ceiling tiles.

| | | | Ultimate | | |
|---|---|---|---|---|---|
| | | | Flexural | | Strength |
| Exam- | Reinforcing | | Strength | COV | Increase |
| ple | Layer ID | Description | (MPa) | (%) | (%) |
| CT1 | Control | — | 0.70 | 8 | — |
| CT2 | C1 | P2-Glass-UDT | 1.74 | 6 | 149 |
| CT3 | C6 | P2-Glass-LFT | 1.60 | 3 | 129 |

| | | | |
|---|---|---|---|
| CT4 | C10* | PC2-Glass-UDT | Did not adhere |

*Bonding temperatures trials included both 155° C. & 175° C.

TABLE 24
Flexural modulus results for reinforced ceiling tiles.

| | | | Flexural | | Modulus |
|---|---|---|---|---|---|
| Exam- | Reinforcing | | Modulus | COV | Increase |
| ple | Layer ID | Description | (MPa) | (%) | (%) |
| CT1 | Control | — | 219 | 17 | — |
| CT2 | C1 | P2-Glass-UDT | 315 | 5 | 44 |
| CT3 | C6 | P2-Glass-LFT | 244 | 6 | 11 |

| | | | |
|---|---|---|---|
| CT4 | C10* | PC2-Glass-UDT | Did not adhere |

*Bonding temperatures trials included both 155° C. & 175° C.

TABLE 25
Strain at peak load for reinforced ceiling tiles.

| | | | Strain at | | Strain |
|---|---|---|---|---|---|
| Exam- | Reinforcing | | Peak Load | COV | Increase |
| ple | Layer ID | Description | (%) | (%) | (%) |
| CT1 | Control | — | 0.5 | 7 | — |
| CT2 | C1 | P2-Glass-UDT | 13.5** | 0 | 2600 |
| CT3 | C6 | P2-Glass-LFT | 13.5** | 0 | 2600 |

| | | | |
|---|---|---|---|
| CT4 | C10* | PC2-Glass-UDT | Did not adhere |

*Bonding temperatures trials included both 155° C. & 175° C.
**Test stopped at 13.5% strain

Tables 23 through 25 show the direct bonding behavior of Case 1 and 3 polymer reinforcing layers to mineral fiber containing ceiling tiles. Significant improvements in strength and stiffness were observed with direct bonding of the copolyester-based UDT to the ceiling tile (Case 1 Example CT2). Discontinuous glass reinforcement likewise showed improvements in modulus and strength (Example CT3), but to a lower level than that of the continuous glass reinforcement. Efforts to directly thermal bond the polypropylene-based reinforcing layer (Case 3 Example CT4) to ceiling tile were unsuccessful. Additionally, strain at peak load was greatly improved by the addition of a reinforcing layer based on the Case 1 polyester example (P2).

### Ceiling Tile Handleability Index

### Examples CT1-CT4 Handleability Index Values for Case 1 Polymers Bonded to Ceiling Tile

Handleability index values were calculated using peak load and deflection values (reference equations 1 and 2) and are presented in Table 26. Note that since slightly different samples widths were used the peak load was appropriately normalized by width for the handleability calculation.

TABLE 26
Handleability Index values for ceiling tile.

| | | | Handle- | | Handle- |
|---|---|---|---|---|---|
| | | | ability | | ability |
| | | | Index | | Index |
| Exam- | Reinforcing | | (mm · N/ | COV | Increase |
| ple | Layer ID | Description | mm · mm) | (%) | (%) |
| CT1 | Control | — | 0.9 | 15 | — |
| CT2 | C1 | P2-Glass-UDT | 53.8 | 5 | 6040 |
| CT4 | C6 | P2-Glass-LFT | 49.6 | 3 | 5560 |

Table 26 illustrates the significant increase in handleability index that occurred when direct bonding a reinforced polyester to one side of mineral-containing ceiling tile. In a similar manner to that described for cement board, the load profile as a function of strain/displacement was compared for Example CT2 (Case 1 polymer with continuous glass fiber reinforcement) and Example CT1 (control). Integration of these traces—a measure of work to failure—yielded 34 mJ for the control sample and 384 mJ for the UDT reinforced sample.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination. As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

What is claimed is:

1. A reinforced mineral-containing substrate comprising:
a thermoplastic reinforcing layer bonded onto at least one surface of a mineral-containing substrate,
wherein said thermoplastic reinforcing layer comprises at least one thermoplastic polymer and at least one reinforcing fiber.

2. The reinforced mineral-containing substrate of claim 1, wherein said thermoplastic polymer comprises polypropylenes, polyethylenes, polystyrenes, polyvinylchlorides, polyamides, polyesters (co-polyesters), acrylics, polycarbonate, or mixtures thereof.

3. The reinforced mineral-containing substrate of claim 1, wherein said thermoplastic polymer comprises a polyester.

4. The reinforced mineral-containing substrate of claim 3, wherein said thermoplastic polyester has a melt phase viscosity in the range of 10³ to 10⁸ Pa-s at 30 to 250° C.

5. The reinforced mineral-containing substrate of claim 3, wherein said thermoplastic polyester is amorphous with a glass transition temperature of at least 50° C.

6. The reinforced mineral-containing substrate of claim 1, wherein said reinforcing fiber comprises glass, carbon, flax, metal, basalt, boron, commingled fibers, polymers, high molecular weight polyethylene, aramid, or mixtures thereof.

7. The reinforced mineral-containing substrate of claim 1, wherein said reinforcing fiber is discontinuous.

8. The reinforced mineral-containing substrate of claim 7, wherein said discontinuous reinforcing fiber is 10-40% by weight of the thermoplastic reinforcing layer.

9. The reinforced mineral-containing substrate of claim 1, wherein said reinforcing fiber is continuous.

10. The reinforced mineral-containing substrate of claim 9, wherein said continuous reinforcing fiber is 10-80% by weight of the thermoplastic reinforcing layer.

11. The reinforced mineral-containing substrate of claim 1, wherein said reinforcing fiber is a mixture of continuous and discontinuous fibers.

12. The reinforced mineral-containing substrate of claim 1, wherein said reinforcing fiber is coated with a sizing or coupling agent.

13. The reinforced mineral-containing substrate of claim 1, further comprising a resin layer between said thermoplastic reinforcing layer and said selected surface, wherein said resin layer comprises at least one thermoplastic polymer.

14. The reinforced mineral-containing substrate of claim 3, wherein said polyester comprises a dicarboxylic acid component and a diol component,
wherein said acid component comprises terephthalic acid (TPA), isophthalic acid (IPA), 1,3- or 1,4-cyclohexane dicarboxylic acid (CHDA), napthalenedicarboxylic acid, stilbenedicarboxylic acid or mixtures thereof; and
wherein said diol component comprises ethylene glycol (EG), 1,4-cyclohexanedimethanol (CHDM), Diethylene glycol (DEG), 2,2,4,4, tetramethyl-1,3 cyclobutanediol (60 mol % cis isomer) (TMCD), 1,2-propanediol, 1,3-propanediol, neopentyl glycol, 1,4-butanediol, 1,5-pentanediol, 1,6-hexanediol, or p-xylene glycol or mixtures thereof.

15. The reinforced mineral-containing substrate of claim 14, wherein said diol component comprises at least 30 mole percent of 1,4-cyclohexanedimethanol (CHDM).

16. The reinforced mineral-containing substrate of claim 1, wherein said thermoplastic reinforcing layer is thermally bonded onto the substrate.

17. The reinforced mineral-containing substrate of claim 1, wherein said thermoplastic reinforcing layer has a thickness of 0.1-2 mm.

18. The reinforced mineral-containing substrate of claim 1, wherein said substrate has a thickness of 1-40 mm.

19. The reinforced mineral-containing substrate of claim 1, wherein the thickness of the substrate increases less than 5% when the thermoplastic reinforcing layer is bonded thereto.

20. The reinforced mineral-containing substrate of claim 1, wherein said mineral-containing substrate is a construction panel or board which comprises gypsum, perlite, magnesium oxide, calcium silicate, vermiculite, cement, mineral wool or mixtures thereof.

21. The reinforced mineral-containing substrate of claim 1, wherein said mineral-containing substrate further comprises cellulose, starch, waxes, coatings, or mixtures thereof.

22. The reinforced mineral-containing substrate of claim 1, wherein said mineral-containing substrate comprises structural panels, gypsum boards, gypsum panels, gypsum wallboards, plasterboard, drywall, wallboards, high density boards, hard boards, impregnated boards, water repellant boards, cement boards, ceiling panels or ceiling tiles.

23. A method for preparing a reinforced mineral-containing substrate, said method comprising:
bonding a prepreg composite directly onto at least one surface of a mineral-containing substrate to thereby form said reinforced mineral-containing substrate;
wherein said bonding forms a direct bond between said prepreg composite and said substrate surface, and
wherein said prepreg composite comprises at least one thermoplastic polyester and at least one reinforcing fiber.

24. The method of claim 23, wherein the peak flexural strength, according to ASTM D790, of said reinforced substrate is at least 20 percent greater than the peak flexural strength of the substrate.

25. The method of claim 23, wherein said bonding occurs in the absence of an adhesive.

26. The method of claim 23, wherein said prepreg composite is a unidirectional tape.

27. The method of claim 26, wherein said unidirectional tape is thermally bonded onto the substrate.

28. The method of claim 26, wherein said unidirectional tape has a thickness of 0.1-2 mm.

29. The method of claim 23, wherein said substrate has a thickness of 1-40 mm.

30. The method of claim 28, wherein the thickness of the substrate increases less than 5% when the unidirectional tape is bonded thereto.

31. The method of claim 23, wherein said thermoplastic polyester has a melt phase viscosity in the range of 10³ to 10⁸ Pa-s at 30 to 250° C.

32. The method of claim 23, wherein said mineral-containing substrate is a construction panel or board which comprises gypsum, perlite, magnesium oxide, calcium silicate, vermiculite, cement, mineral wool or mixtures thereof.

33. The method of claim 23, wherein said mineral-containing substrate further comprises cellulose, starch, waxes, coatings, or mixtures thereof.

34. The method of claim 23, wherein said mineral-containing substrate comprises structural panels, gypsum boards, gypsum panels, gypsum wallboards, plasterboard, drywall, wallboards, high density boards, hard boards, impregnated boards, water repellant boards, cement boards, ceiling panels or ceiling tiles.

35. The method of claim 23, wherein said bonding comprises heating said prepreg composite and/or said substrate to temperatures in the range of 30 to 300° C. and contacting said prepreg with said substrate surface under pressure using a roll lamination process.

36. The method of claim 23, wherein said bonding comprises heating said prepreg composite to temperatures in the range of 30 to 300° C. to form a heated prepreg composite and contacting said heated prepreg with said substrate surface under a pressure in the range of 0.03 to 3.40 MPa, wherein the temperature and pressure are maintained for 1 to 7 minutes or less, and wherein the peak flexural strength, according to ASTM D790, of said reinforced substrate is at least 20 percent greater than the peak flexural strength of the substrate.

37. The method of claim 34, wherein said bonding comprises contacting said prepreg composite with said substrate surface wherein said substrate is gypsum wallboard and then heating said prepreg composite and said substrate to a temperature in the range of 30 to 150° C. under a pressure in the range of 0.17 to 2.50 MPa, wherein the temperature and pressure are maintained for 1 to 7 minutes or less.

38. The method of claim 34, wherein said bonding comprises contacting said prepreg composite with said substrate surface wherein said substrate is cement board and then heating said prepreg composite and said substrate to a temperature in the range of 30 to 300° C. under a pressure in the range of 0.34 to 3.40 MPa, wherein the temperature and pressure are maintained for 1 to 5 minutes or less.

39. The method of claim 34, wherein said bonding comprises contacting said prepreg composite with said substrate surface wherein said substrate is ceiling tile and then heating said prepreg composite and said substrate to a temperature in the range of 30 to 300° C. under a pressure in the range of 0.03 to 0.34 MPa, wherein the temperature and pressure are maintained for 1 to 7 minutes or less.

40. The method of claim 37, wherein the peak flexural strength, according to ASTM D790, of said reinforced substrate is at least 30 percent greater than the peak flexural strength of the substrate.

41. The method of claim 38 or 39, wherein the peak flexural strength, according to ASTM D790, of said reinforced substrate is at least 50 percent greater than the peak flexural strength of the substrate.

42. The method of claim 37, 38 or 39, wherein the flexural modulus, according to ASTM D790, of said reinforced substrate is at least 5 percent greater than the flexural modulus of the substrate.

43. The method of claim 37, 38 or 39, wherein the handleability index, according to ASTM C1185, of said reinforced substrate shows at least 100% improvement.

44. The method of claim 37, wherein the nail pull resistance, according to ASTM C473, of said reinforced substrate shows at least a 10% improvement.

45. The method of claim 24, wherein said reinforcing fiber comprises glass, carbon, flax, metal, basalt, boron, commingled fibers, polymers, high molecular weight polyethylene, aramid, or mixtures thereof.

46. The method of claim 24, wherein said polyester comprises a dicarboxylic acid component and a diol component;
wherein said acid component comprises terephthalic acid (TPA), isophthalic acid (IPA), 1,3- or 1,4-cyclohexane dicarboxylic acid (CHDA), napthalenedicarboxylic acid, stilbenedicarboxylic acid or mixtures thereof; and
said diol component comprises ethylene glycol (EG), 1,4-cyclohexanedimethanol (CHDM), Diethylene glycol (DEG), 2,2,4,4, tetramethyl-1,3 cyclobutanediol (60 mol % cis isomer) (TMCD), 1,2-propanediol, 1,3-propanediol, neopentyl glycol, 1,4-butanediol, 1,5-pentanediol, 1,6-hexanediol, or p-xylene glycol or mixtures thereof.

47. The method of claim 24, wherein said diol component comprises at least 30 mole percent of 1,4-cyclohexanedimethanol (CHDM).

48. A reinforced mineral-containing substrate comprising:
a unidirectional tape thermally bonded onto at least one surface of a mineral-containing building panel substrate,
wherein said unidirectional tape has a thickness of 0.1-2 mm and comprises at least one thermoplastic polyester and at least one reinforcing fiber,
wherein said reinforcing fiber is glass and comprises 10-80% by weight of the thermoplastic reinforcing layer,
wherein said building panel substrate has a thickness of 1-40 mm and comprises structural panels, gypsum boards, gypsum panels, gypsum wallboards, plasterboard, drywall, wallboards, high density boards, hard boards, impregnated boards, water repellant boards, cement boards, ceiling panels or ceiling tiles,
wherein said thermoplastic polyester has a melt phase viscosity in the range of 10³ to 10⁸ Pa-s at 30 to 250° C. and is amorphous with a glass transition temperature of at least 50° C., and
wherein said polyester comprises a dicarboxylic acid component and a diol component:
wherein said acid component comprises terephthalic acid (TPA), isophthalic acid (IPA) or mixtures thereof; and
wherein said diol component comprising 0 to 95 mole percent of 1,4-cyclohexanedimethanol (CHDM) and 5 to 100 mole percent of 2,2,4,4, tetramethyl-1,3 cyclobutanediol (60 mol % cis isomer) (TMCD).

49. A reinforced mineral-containing substrate comprising:
a unidirectional tape thermally bonded onto at least one surface of a mineral-containing building panel substrate,
wherein said unidirectional tape has a thickness of 0.1-2 mm and comprises at least one thermoplastic polyester and at least one reinforcing fiber,
wherein said reinforcing fiber is glass and comprises 10-80% by weight of the thermoplastic reinforcing layer,
wherein said building panel substrate has a thickness of 1-40 mm and comprises structural panels, gypsum boards, gypsum panels, gypsum wallboards, plasterboard, drywall, wallboards, high density boards, hard boards, impregnated boards, water repellant boards, cement boards, ceiling panels or ceiling tiles,
wherein said thermoplastic polyester has a melt phase viscosity in the range of 10³ to 10⁸ Pa-s at 30 to 250° C. and is amorphous with a glass transition temperature of at least 50° C., and
wherein said polyester comprises a dicarboxylic acid component and a diol component;
wherein said acid component comprises terephthalic acid (TPA), isophthalic acid (IPA) or mixtures thereof; and
wherein said diol component comprising 0 to 40 mole percent of 1,4-cyclohexanedimethanol (CHDM) and 60 to 100 mole percent of ethylene glycol (EG).
